(19) United States
(12) Patent Application Publication
(10) Pub. No.: US 2025/0220631 A1
(43) Pub. Date: Jul. 3, 2025

(54) Device Localization Independent of Clock Synchronization

(71) Applicant: Cisco Technology, Inc., San Jose, CA (US)

(72) Inventors: Navid Reyhanian, Fremont, CA (US); Ardalan Alizadeh, Campbell, CA (US); Peiman Amini, Fremont, CA (US); Jerome Henry, Pittsboro, NC (US)

(21) Appl. No.: 18/932,384

(22) Filed: Oct. 30, 2024

Related U.S. Application Data
(60) Provisional application No. 63/616,435, filed on Dec. 29, 2023.

(51) Int. Cl. H04W 64/00; G01S 5/12

(52) U.S. Cl. CPC H04W 64/003; G01S 5/12

(57) ABSTRACT

Existing device localization strategies can lead to significant localization errors due to clock synchronization discrepancies among network devices. To address this, devices, systems, methods, and processes for facilitating device localization independent of clock synchronization are described herein. A reference network device coupled to multiple peer devices receives a blink signal from a wireless transceiver and a set of notifications from the peer devices. The set of notifications indicates arrival and processing time durations of the blink signal at respective peer devices. The reference network device assesses a latency value associated with each of the set of notifications and estimates time difference of arrivals (TDoAs) for the blink signal based on a clock of the reference network device and the assessed latency values. The reference AP determines a location of the wireless transceiver based on the TDoAs estimated without clock synchronization between the reference network device and the peer devices.

This application claims the benefit of U.S. Provisional Patent Application No. 63/616,435, filed Dec. 29, 2023, which is incorporated by reference herein in its entirety.

The present disclosure relates to communication networks. More particularly, the present disclosure relates to device localization independent of clock synchronization.

### BACKGROUND

Various applications, such as navigation, asset tracking, smart infrastructure management, or the like, require precise location of mobile devices for their operations. One widely adopted method for achieving this is Uplink Time Difference of Arrival (UL-TDoA) technique. In the UL-TDoA method, a mobile device transmits a message, for example, a “blink” signal, that is received by multiple time-synchronized anchors. These anchors then compare the timestamps of the received blink signal to estimate the position of the mobile device using hyperbolic localization. The reliance of UL-TDoA on a single transmission reduces power consumption, making it particularly suitable for large-scale applications.

However, one of the major limitations of the UL-TDoA method is its dependence on frequent and precise over-the-air time synchronization between the anchors. The UL-TDoA based system needs anchors to synchronize, for example, after every 200 ms, and the duration of each synchronization event can range, for example, from 10 ms to 40 ms. The synchronization process consumes a significant portion of the available airtime of ultra-wide band (UWB), reducing the overall efficiency of the system. The potential for interference between UWB and Wi-Fi signals is another concern, especially when the UWB radio is co-located with the anchors (e.g., Wi-Fi APs).

This can lead to out-of-band power leakage, which could degrade Wi-Fi performance, particularly in environments where both technologies are utilized simultaneously. Further, UL-TDoA is highly sensitive to synchronization errors between the clocks of the anchors. Even minor discrepancies in clock synchronization, measured in picoseconds, can lead to significant localization errors. If the clocks of the anchors are not perfectly synchronized, hyperbolic curves utilized to determine the location of the mobile device do not intersect accurately, leading to errors greater than 10 cm, which can compromise the reliability of the system. The need for frequent synchronization and the potential for interference in UL-TDoA based system may limit its scalability in densely populated environments, where numerous devices and APs must coexist without degrading performance.

### SUMMARY OF THE DISCLOSURE

Systems and methods for facilitating device localization independent of clock synchronization in accordance with embodiments of the disclosure are described herein. In many embodiments, a device may include a processor and a memory communicatively coupled to the processor. The device may be associated with a clock. The memory may include a localization logic that may be configured to receive a blink signal and a set of notifications, where each notification of the set of notifications may be configured to indicate an arrival and a processing time duration of the blink signal at a corresponding peer device of a plurality of peer devices. The localization logic may further be configured to assess a latency value associated with each of the set of notifications, and estimate, for each device pair of a plurality of device pairs, a time difference of arrival (TDoA) for the blink signal based on the clock and the assessed latency value.

In a number of embodiments, a device pair of the plurality of device pairs may include one of a combination of the device and a peer device of the plurality of peer devices or a combination of two peer devices of the plurality of peer devices.

In a variety of embodiments, to estimate the TDoA for the device pair including the combination of the device and the peer device, the localization logic may further be configured to record, with reference to the clock, a local arrival timestamp of the blink signal at the device and a first arrival timestamp of a notification of the set of notifications at the device, where the notification may be received from the peer device, and determine a second arrival timestamp of the blink signal at the peer device based on the first arrival timestamp and the assessed latency value associated with the notification, where the TDoA of the blink signal for the device pair may be estimated as a function of the local arrival timestamp and the second arrival timestamp.

In various embodiments, to estimate the TDoA for the device pair including the combination of the two peer devices, the localization logic may further be configured to record, with reference to the clock, a first arrival timestamp of a first notification and a second arrival timestamp of a second notification, of the set of notifications at the device, where the first notification may be received from a first peer device of the two peer devices and the second notification may be received from a second peer device of the two peer devices, and determine a third arrival timestamp of the blink signal at the first peer device and a fourth arrival timestamp of the blink signal at the second peer device, where the third arrival timestamp may be determined based on the first arrival timestamp and the assessed latency value associated with the first notification, and the fourth arrival timestamp may be determined based on the second arrival timestamp and the assessed latency value associated with the second notification, and where the TDoA of the blink signal for the device pair may be estimated as a function of the third arrival timestamp and the fourth arrival timestamp.

In more embodiments, in response to receiving the set of notifications, the localization logic may be further configured to determine a travel time duration associated with each notification of the set of notifications.

In additional embodiments, a location of each of the plurality of peer devices may be known to the localization logic, and where the travel time duration associated with each notification of the set of notifications may be determined based on the known location of the corresponding peer device.

In further embodiments, the latency value for each notification of the set of notifications may be assessed based on the processing time duration and the travel time duration associated with a corresponding notification of the set of notifications.

In still more embodiments, the localization logic may be further configured to assign a priority order to the plurality of peer devices.

In still further embodiments, one or more notifications in the set of notifications may be received sequentially based on the priority order.

In still additional embodiments, the priority order may be assigned based on a distance of each peer device of the plurality of peer devices from the device.

In some more embodiments, a peer device, of the plurality of peer devices, nearest to the device may be assigned a highest priority in the priority order.

In yet various embodiments, the priority order may be assigned based on a count of network clusters each peer device of the plurality of peer devices is associated with.

In yet more embodiments, a peer device, of the plurality of peer devices, associated with a least count of network clusters may be assigned a highest priority in the priority order.

In still yet more embodiments, the blink signal may be received from a wireless transceiver.

In many further embodiments, the localization logic may further be configured to determine a location of the wireless transceiver based on the estimated TDoA associated with each device pair of the plurality of device pairs.

In many additional embodiments, the device may correspond to a reference access point (AP) and the plurality of peer devices correspond to secondary APs.

In still yet further embodiments, the TDoA for each device pair of the plurality of device pairs may be estimated independently of whether the plurality of peer devices are clock synchronized with the clock of the device.

In still yet additional embodiments, a peer device may include a processor and a memory communicatively coupled to the processor. The memory may include a localization logic that is configured to receive a blink signal, record a processing time duration of the blink signal, and transmit a notification, indicating an arrival and the processing time duration of the blink signal, to a reference device, where the notification may be utilized for time difference of arrival (TDoA) estimation of the blink signal at the reference device.

In several embodiments, the peer device may be associated with one or more network clusters.

In several more embodiments, a method may include receiving a blink signal and a set of notifications, where each notification of the set of notifications may be configured to indicate an arrival and a processing time duration of the blink signal at a corresponding peer device of a plurality of peer devices, assessing a latency value associated with each of the set of notifications, and estimating, for each device pair of a plurality of device pairs, a time difference of arrival (TDoA) for the blink signal based on a reference clock and the assessed latency value.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that implement a localization logic in accordance with various embodiments of the disclosure;

FIG. 2 is a schematic block diagram of an example network for executing device localization independent of clock synchronization in accordance with various embodiments of the disclosure;

FIG. 3 is a conceptual diagram of an example multi-cluster network facilitating device localization independent of clock synchronization in accordance with various embodiments of the disclosure;

FIG. 4 is a conceptual diagram representing priority based time of arrivals (ToAs) of a set of notifications in a multi-cluster network scenario in accordance with various embodiments of the disclosure.

FIG. 5 is a flowchart showing a process for estimation of time difference of arrival (TDoA) independent of clock synchronization for a single network cluster in accordance with various embodiments of the disclosure;

FIG. 6 is a flowchart showing a process for estimation of TDoA without clock synchronization in accordance with various embodiments of the disclosure;

FIG. 7 is a flowchart showing a process for estimation of TDoA based on a priority order in accordance with various embodiments of the disclosure;

FIG. 8 is a flowchart showing a process for estimation of TDoA in a multi-cluster scenario in accordance with various embodiments of the disclosure;

FIG. 9 is a flowchart showing a process for transmission of a notification by a peer device for device localization in accordance with various embodiments of the disclosure; and

FIG. 10 is a conceptual block diagram of a device suitable for configuration with a localization logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate device localization independent of clock synchronization. The device that needs to be tracked or localized may be connected to a wireless network and may utilize wireless localization methods for determining its location within a certain area using wireless communication signals. For example, the wireless localization techniques primarily utilize Two-Way Ranging (TWR) and Uplink Time Difference of Arrival (UL-TDoA) methods. TWR generally requires mobile devices, for example, tags or smartphones, to exchange multiple messages with a network of anchors (e.g., access points “APs”) to determine the location of the mobile devices. For a two-dimensional (2D) position estimation, the TWR method necessitates communication with at least three anchors. In contrast, UL-TDoA offers a more efficient solution. Here, the mobile devices transmit a single signal or “blink” signal that is captured by multiple time synchronized anchors. By comparing the timestamps of the received blink signal, the anchors can estimate the location of the mobile devices through hyperbolic localization. This single transmission of the UL-TDoA method minimizes power usage, making it suitable for large-scale applications, such as corporate asset monitoring, and maintaining long battery life.

Despite the various improvements offered by UL-TDoA, device localization using UL-TDoA has several challenges that may include, for example, dependence on frequent and precise over-the-air time synchronization between anchors. The UL-TDoA based system requires the anchors to synchronize, for example, every 200 milliseconds, with each synchronization event lasting for several milliseconds. Since the synchronization process consumes a considerable portion of the airtime of Ultra-Wideband (UWB), it reduces the overall efficiency of the system. Another limitation with UL-TDoA is the risk of interference, especially when UWB radios are located near Wi-Fi APs. This proximity can cause out-of-band power leakage, which may negatively impact Wi-Fi performance, particularly in environments where both technologies are deployed together. Further, the accuracy of UL-TDoA is highly dependent on precise synchronization of the clocks of the anchors. Even slight discrepancies can lead to significant localization errors. Without perfect clock synchronization, hyperbolic curves utilized to calculate the location of the mobile devices may not intersect correctly, resulting in significant errors. Although UL-TDoA generally supports more devices than TWR, its need for frequent synchronization and the possibility of interference could limit its scalability in crowded environments, where many devices and APs must function without degrading overall performance.

Therefore, the present disclosure provides a network device (e.g., a Real time location server “RTLS”, or a reference AP, a reference device, a master AP, a primary AP, or the like) that facilitates device localization independent of clock synchronization. Hereinafter, the network device is referred to as the “reference AP”. In the wireless network, the reference AP may be communicatively coupled to a plurality of peer devices (e.g., secondary APs, anchors, or the like) that provide tracking coverage in a given area to one or more wireless transceivers associated with mobile devices that require tracking or location detection. Hereinafter, the plurality of peer devices are referred to as “anchors”. The anchors may be devices with known locations in the given area and may participate in accurate localization of the one or more wireless transceivers. In other words, the anchors may be fixed reference points placed strategically within the given area for supporting device localization functions. The anchors may be associated with one or more network clusters, each managed by one reference AP. Hereinafter, the one or more wireless transceivers are referred to as “tags”. A tag is a mobile device or a sensor attached to or included in an object, asset, or person that needs to be tracked. The tag can be a UWB tag, Radio Frequency Identification (RFID) tag, or another type of wireless transceiver depending on requirements associated with the system. The tag may emit a signal, often referred to as a “blink signal,” which is received by multiple anchors in the network. In other words, the blink signal may be a single, brief transmission intended to be received by multiple anchors including the reference AP within the network.

To track the location of the tag within the network, the anchors may keep their receivers on and listen for the blink signal from the tag. Each of the anchors may be further configured to record a processing time duration required to process the received blink signal. In other words, each anchor may be configured to record the processing time duration of the blink signal and thereafter transmit a notification to the reference AP indicating an arrival and the processing time duration of the blink signal. Such notifications may be utilized for time difference of arrival (TDoA) estimation of the blink signal at the reference AP.

In various embodiments, the reference AP facilitating the device localization independent of clock synchronization may include a processor, a transceiver, and a memory communicatively coupled to the processor. In many embodiments, the reference AP may be configured with a clock. The clock may be equipped in the reference AP or may be externally coupled to the reference AP. The “clock” may include suitable logic, circuitry, and/or interfaces to execute a precise timing mechanism or oscillator that keeps track of time within the reference AP. The clock may be configured to measure an exact time at which signals, for example, blink signals from the tag and a set of notifications from various anchors are received. The reference AP may be communicatively coupled to the anchors and the tag. In a number of embodiments, the reference AP may be further equipped with a localization logic, for example, stored in the memory or implemented as a hardware component in the reference AP device, to facilitate localization of one or more tags.

In a variety of embodiments, the reference AP may receive the blink signal transmitted by the tag and record, with reference to the clock, a local arrival timestamp of the blink signal at the reference AP. The reference AP may receive the set of notifications from the anchors that also received the blink signal, and further record a first arrival timestamp of each notification of the set of notifications based on its clock. Each notification of the set of notifications may be configured to indicate the arrival and the processing time duration of the blink signal at the corresponding anchor. The reference AP may be further configured to determine a travel time duration associated with each notification of the set of notifications to reach the reference AP from the corresponding anchor. For each notification, the travel time duration may be determined based on the known location of respective anchor and the distance between the reference AP and the anchor.

There is often a delay or latency associated with the process of the reference AP receiving the set of notifications from the anchors. The latency might be due to communication delays, processing times at the anchors, or network transmission time. Thus, in a variety of embodiments, the reference AP may be configured to assess a latency value for each notification of the set of notifications. The latency value may be assessed based on the processing time duration and the travel time duration associated with the corresponding notification. In additional embodiments, based on each received notification, the reference AP may determine a second arrival timestamp of the blink signal at the respective anchor. The second arrival timestamp may be determined with reference to the clock of the reference AP. In other words, the reference AP utilizes its own clock to determine the second arrival timestamp of the blink signal at the respective anchors. For each notification, the reference AP may determine the second arrival timestamp based on the first arrival timestamp recorded at the reference AP and the assessed latency value associated with the corresponding notification. In other words, the reference AP may utilize the first arrival timestamp and adjust the first arrival timestamp by the assessed latency value to determine the second arrival timestamp. For example, to determine the second arrival timestamp of the blink signal at an anchor, the reference AP may subtract the assessed latency value associated with the notification of the anchor from the first arrival timestamp of receiving the notification at the reference AP. The reference AP may perform the second arrival timestamp determination for each anchor from which the notification is received.

In further embodiments, the reference AP may further identify a plurality of device pairs. A device pair of the plurality of device pairs may include one of a combination of the reference AP and an anchor of the plurality of anchors or a combination of two anchors of the plurality of anchors. Further, the reference AP may be configured to estimate, for each device pair, a TDoA for the blink signal based on the clock and the assessed latency value. In an example embodiment, the TDoA of the blink signal for the device pair that may include the combination of the reference AP and an anchor of the plurality of anchors may be estimated as a function of the local arrival timestamp recorded based on the clock and the second arrival timestamp of the anchor determined based on the assessed latency value. For example, if an arrival time of the blink signal at the reference AP determined based on the clock of the reference AP is tr and an arrival time of the blink signal at a first anchor based on the clock of the reference AP is t₁, the reference AP may estimate the TDoA for the device pair including the reference AP and the first anchor as tr−t₁. In still more embodiments, the TDoA of the blink signal for the device pair that may include the combination of the two anchors may be estimated as a function of the second arrival timestamps of the two anchors. For example, if an arrival time of the blink signal at the first anchor determined based on the clock of the reference AP is t₁ and an arrival time of the blink signal at a second anchor based on the clock of the reference AP is t₂, the reference AP may estimate the TDoA as t₂−t₁. Thus, TDoA for each device pair of the plurality of device pairs may be estimated independently of whether the anchors are clock synchronized with the clock of the reference AP or not.

In some more embodiments, the reference AP may be further configured to determine a location of the tag based on the estimated TDoA associated with each device pair of the plurality of device pairs. For example, the reference AP may aggregate all TDoAs to form a set of non-linear equations (e.g., hyperbolic equations). By solving the set of hyperbolic equations, the reference AP may generate a set of intersecting hyperbolas. That is to say, for every device pair in the particular network cluster, a hyperbola is created using TDoA data. The point or an area where the hyperbolas intersect may indicate the location of the tag. By utilizing the estimated TDoAs and the set of non-linear equations, the reference AP may determine the location of the tag independently of whether the anchors are clock synchronized with the clock of the reference AP.

When multiple anchors transmit these notifications to the reference AP without any coordinated timing, the likelihood of message collisions increases because time difference of arrival between the notifications at the reference AP is often shorter than the frame duration of each notification. That is to say, each anchor may transmit its notification as soon as the anchor processes the blink signal. This lack of coordination means that multiple anchors might transmit their notifications almost simultaneously, without considering when other anchors are transmitting theirs. If the frame duration of the notifications is longer than the time difference of arrival between the notifications at the reference AP, there may be a high chance that the notifications may overlap or collide. The “frame duration” may refer to the length data frame to be transmitted from one anchor to the reference AP as a notification. In scenarios where the reference AP can only process one notification at a time, the overlapping notifications can lead to loss of information or the need for retransmissions.

Therefore, in still further embodiments, the reference AP may be configured to assign a priority order to the anchors based on a distance of each anchor from the reference AP and/or channel delay between each anchor from the reference AP. For example, the anchor nearest to the reference AP may be assigned a highest priority in the priority order. Thus, in one or more embodiments, the plurality of anchors transmit corresponding notifications sequentially based on the priority order. Thus, the reference AP may be configured to receive the set of notifications sequentially based on the priority order. In yet more embodiments, the reference AP may be configured to consider that the blink signal has not been received by an anchor if a notification from the anchor is not received in the assigned priority order. In more embodiments, the reference AP may be configured to wait until the reference AP receives the notification from the last AP in the priority order or until a defined time duration of receiving the notification from the last AP expires.

In a multi-network cluster scenario, an anchor can belong to one or more network clusters, where each network cluster may be managed by a unique reference AP. Thus, in many further embodiments, an anchor belonging to multiple network clusters may transmit the notification to all associated reference APs upon blink signal arrival at the anchor. In many additional embodiments, the anchors in the given area may be assigned the priority order based on a count of network clusters each anchor is associated with, and the transmission of notifications from the anchors may be scheduled in stages based on the count of network clusters the anchors are associated with. The anchor associated with the least count of network clusters may be assigned to a first stage of transmission. The anchor associated with N^{th} count of network clusters may be assigned to an N^{th} stage of transmission. Within each stage, anchors may be assigned priorities as per the distance or channel delay from respective reference AP(s). Further, each reference AP associated with a particular network cluster may estimate a TDoA for each device pair associated with the particular network cluster. In still yet further embodiments, once the reference APs have estimated the TDoAs for device pairs in the respective network cluster, the reference APs may forward the estimated TDoAs to a controller coupled to the reference APs. The controller may include suitable logic, circuitry, and/or interfaces to execute a localization of the tag. In still yet additional embodiments, the controller may be configured to aggregate all received TDoAs to obtain intersecting hyperbolas. The intersecting hyperbolas indicate the location of the tag. The greater the number of hyperbolas, the narrower is the region of location of the tag.

Thus, facilitating device localization independent of clock synchronization may significantly enhance network scalability, efficiency, and flexibility by overcoming hardware limitations. It simplifies the system architecture by removing the need for highly precise and frequent synchronization across the network, reducing both complexity and costs. This independence enhances the robustness of the localization process, making it less vulnerable to synchronization errors or clock drift, which can degrade accuracy. Additionally, it can improve scalability, allowing more devices to be tracked simultaneously without the overhead of maintaining synchronization across numerous APs. Finally, it can lead to lower power consumption, as devices don't need to perform frequent synchronization tasks.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

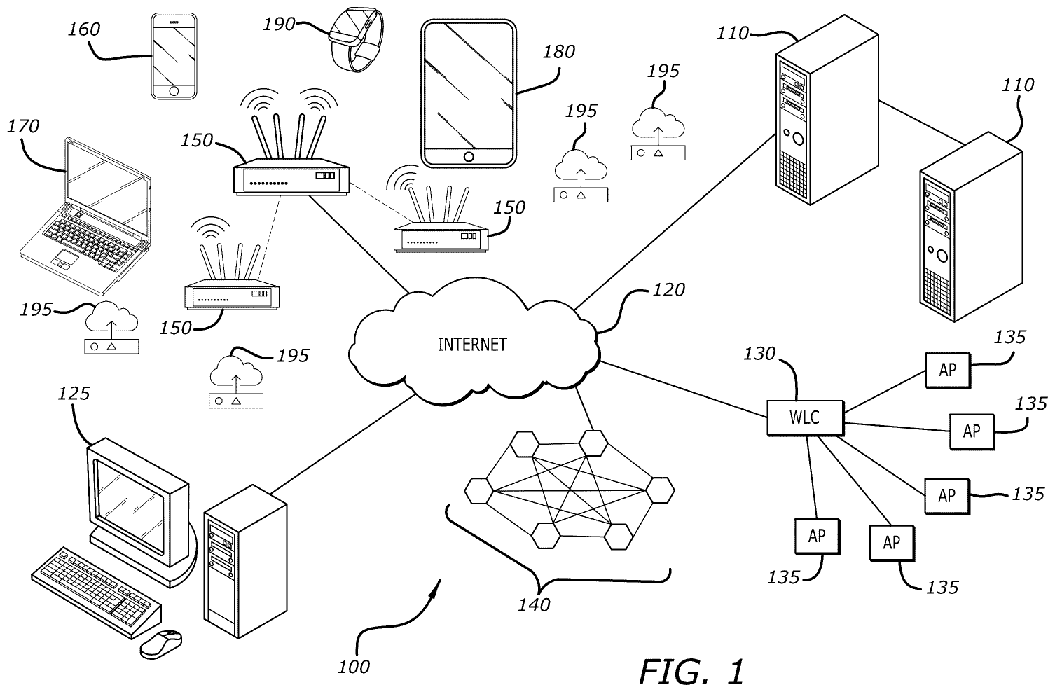

Referring to FIG. 1, a conceptual network diagram of various environments that implement a localization logic in accordance with various embodiments of the disclosure is shown. The localization logic can include various hardware and/or software deployments and can be configured in a variety of ways. In some non-limiting examples, the localization logic can be configured as a standalone device, exist as a logic within another network device, be distributed among various network devices operating in tandem, or remotely operated as part of a cloud-based network management tool. The embodiments shown in FIG. 1 illustrate a network 100 comprising a plurality of network devices that can implement the localization logic for device localization that is independent of clock synchronization.

In many embodiments, the network 100 may include cloud based centralized management servers 110 connected to a communication network 120 (shown as the Internet). The communication network 120 can include wired networks or wireless networks. The centralized management servers 110 can be configured to execute the localization logic. In a variety of embodiments, the network 100 may further include remote networks, such as, but not limited to a deployed network 140.

In a number of embodiments, the network 100 may include a plurality of network access points (APs) 150. The APs 150 may facilitate Wi-Fi connections for various electronic devices, such as but not limited to, tags or mobile computing devices including laptop computers 170, cellular phones 160, portable tablet computers 180, wearable computing devices 190, and internet of things (IoT) devices 195. The IoT devices 195 may refer to devices that are interconnected physical objects embedded with sensors, software, and other technologies that enable them to collect, exchange, and act on data over the internet. Examples of IoT devices may include, for example, smart home devices, security cameras, and voice assistants, as well as industrial IoT applications like connected machinery, environmental sensors in agriculture, and wearable health monitors. The tags may be configured with wireless transceivers to emit a signal referred to as “blink signal” which is received by multiple APs in the network. The tags are usually battery-powered and designed to be energy-efficient, as it only transmits signals intermittently. The tags can be an ultra-wideband (UWB) tag, Radio Frequency Identification (RFID) tag, or another type of wireless device depending on the requirement of the network. Further, the tags can be in-built or externally associated with the mobile computing devices for localization and tracking purposes. The APs 150 can be configured to execute the localization logic for locating the tags. However, in further embodiments, the localization logic may be operated as distributed logic across multiple APs 150. In the embodiment depicted in FIG. 1, the plurality of network APs 150 can operate as the localization logic in a distributed manner or may have one specific AP (e.g. a reference AP) to implement the localization logic for the various APs.

In more embodiments, the network 100 may include a wireless Local Area Network (LAN) controller (WLC) 130 configured to monitor, control or manage the APs 135 connected to the WLC 130, either wired or wirelessly. The WLC 130 and/or the APs 135 can be configured to execute the localization logic. The APs 135, 150 may belong to one or more network clusters and may also be referred to as “anchors”. The anchors may be fixed reference points placed strategically within the given area. The APs 135, 150 may receive the blink signal from the tags. The APs 135, 150 may be further configured to record a processing time duration of the blink signal and thereby transmit a notification to an AP, designated as a reference AP among the APs 135, 150, indicating an arrival and the processing time duration of the blink signal. These notifications may be utilized for time difference of arrival (TDoA) estimation of the blink signal. The term “TDoA” may refer to a localization technique that determines the position of a signal-emitting device by measuring the difference in arrival times of the blink signal at multiple APs. Thus, the reference AP may utilize TDoA data to determine the location of the tag with high precision. In still more embodiments, a personal computer 125 may be utilized to access and/or manage various aspects of the network 100, either remotely or within the network itself. In the embodiment depicted in FIG. 1, the personal computer 125 may communicate over the communication network 120 and can access the servers 110, the network APs 150, or the WLC 130.

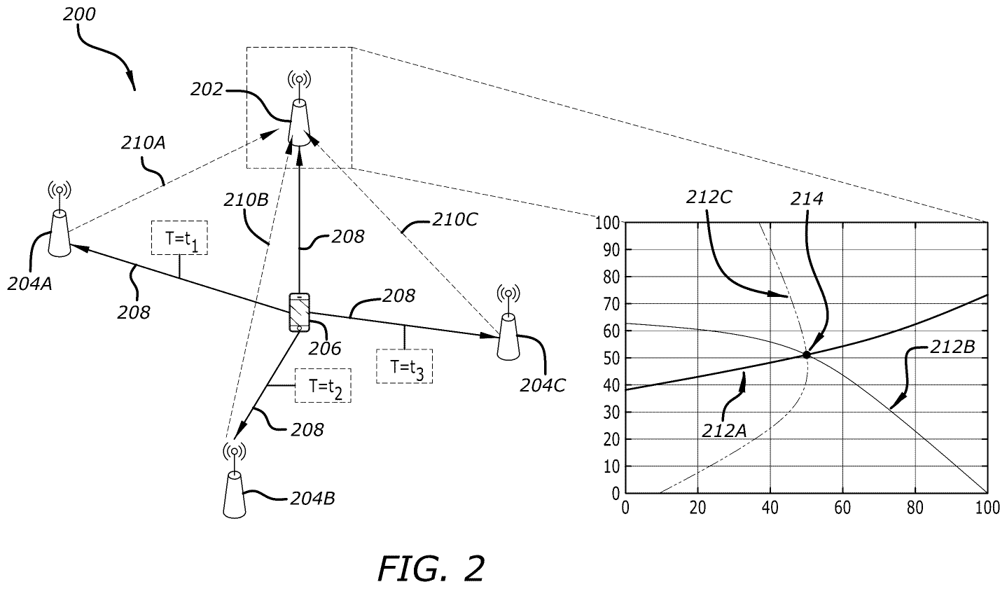

Although a specific embodiment for a conceptual network diagram of various environments that implement a localization logic suitable for carrying out the various steps, processes, methods, and operations described herein is discussed with respect to FIG. 1, any of a variety of systems and/or processes may be utilized in accordance with embodiments of the disclosure. For example, various other transmissions can be used to locate devices in wireless localization network. For instance, Continuous Wave (CW) signals, chirp signals, UWB pulse trains and Wi-Fi probe requests, Bluetooth beacons, acoustic signals, packet data with embedded timestamps, Angle of Arrival (AoA) measurements or the like also contribute to determining device locations depending on the requirements of a system for accuracy and power efficiency. The elements depicted in FIG. 1 may also be interchangeable with other elements of FIGS. 2-10 as required to realize a particularly desired embodiment.

Referring to FIG. 2, a schematic block diagram of an example network 200 for executing device localization independent of clock synchronization in accordance with various embodiments of the disclosure is shown. The network 200 may correspond to a wireless network facilitating wireless localization and tracking of one or more mobile devices in a given area.

In many embodiments, the network 200 may include a network device (e.g., a Real time location server “RTLS”, or a reference AP, a master AP, a primary AP, or the like) that facilitates device localization independent of clock synchronization. In FIG. 2, the network device is illustrated as a reference AP 202. The reference AP 202 may be configured to manage a single network cluster. Within the network 200, the reference AP 202 may be connected to multiple peer devices (e.g., secondary APs, anchors, or similar devices, collectively referred to as “anchors”) that provide tracking coverage for the given area, enabling the detection and localization of the one or more wireless transceivers such as tags. For the sake of brevity, only one tag 206 is shown in FIG. 2. The anchors may be strategically positioned at known locations to facilitate accurate tracking of the tag 206. The anchors may act as fixed reference points within the area, and may be organized into one or more network clusters, each of which is managed by the single reference AP 202. The term “tag” may refer to mobile devices or sensors that are attached to objects, assets, or individuals requiring tracking. Examples of the tag 206 may include a UWB tag, an RFID tag, or any other types of wireless transceiver depending on the network requirements. The tag 206 may emit signals (e.g., periodically, at random time intervals, or upon probing), known as “blink signals,” intended to be received by the anchors throughout the network 200, including the reference AP 202. The blink signal may correspond to a brief transmission designed for reception by all relevant anchors in a network. The anchors and the reference AP 202 may be configured to receive and detect the blink signal, enabling precise location tracking of the tag 206. Further, in the example embodiment shown in FIG. 2, the reference AP 202 is shown to be communicatively coupled to three anchors 204A-C (such as a first anchor 204A, a second anchor 204B, and a third anchor 204C) to determine the location of the tag 206.

In various embodiments, the reference AP 202 may include a processor, a transceiver, and a memory communicatively coupled to the processor. In many embodiments, the reference AP 202 may be configured with a clock. The clock may be equipped in the reference AP 202 or may be externally coupled to the reference AP. The clock may include suitable logic, circuitry, and/or interfaces to execute a precise timing mechanism or oscillator that keeps track of time within the reference AP 202. In a number of embodiments, the reference AP 202 may be further equipped with a localization logic (for example, stored in the memory or implemented as a hardware component in the reference AP 202) to facilitate localization of the tag 206.

In a variety of embodiments, the tag 206 may emit a blink signal 208. The blink signal 208 may include basic information, such as tag's identifier (ID), and may be transmitted wirelessly. To track the location of objects within the network 200, the anchors 204A-C may be listening for blink signals. Thus, when the tag 206 transmits the blink signal 208, the blink signal 208 may be received by the three anchors 204A-C and the reference AP 202. In various embodiments, the blink signal 208 may be received by the three anchors 204A-C and the reference AP 202 at slightly different times, depending on the distance of each anchor 204A-C and the reference AP 202 from the tag 206. For example, the first anchor 204A may have the shortest distance to the tag 206, and hence may receive the blink signal 208 within a time duration of T=t₁ from a time instance the blink signal 208 was emitted. Likewise, the second anchor 204B may receive the blink signal 208 within a time duration of T=t₂ and the third anchor 204C may receive the blink signal 208 within a time duration of T=t₃.

In many embodiments, each anchor 204A-C may also be equipped with a local clock. The “local clock” may also include suitable logic, circuitry, and/or interfaces to execute a precise timing mechanism or oscillator that keeps track of time within each anchor 204A-C. The local clock may be configured to measure the exact time at which signals (for example, the blink signal 208 from the tag 206) are received. Each anchor 204A-C, based on the corresponding local clock, may record the exact time of arrival “ToA” of the blink signal 208. For example, based on its local clock, the first anchor 204A may record that the blink signal 208 is received at “T1” timestamp. Likewise, based on their local clocks, the second anchor 204B and the third anchor 204C may record that the blink signal 208 is received at “T2” and “T3” timestamps, respectively.

In further embodiments, each anchor 204A-C may also be configured to measure and record a time duration (tₚⁱ) to process the blink signal 208. Here “i” may refer to an integer associating with an i^{th} anchor and i=1, 2 and 3 in the example embodiment shown in FIG. 2. Each anchor 204A-C may measure and record the corresponding time duration (tₚⁱ) based on the respective local clocks. For example, after recording the ToA “T1”, the first anchor 204A may need to process the blink signal 208 and/or the timestamp data “T1”, which may take the time duration of tₚ¹. In other words, tₚ¹ refers to the total time required for the first anchor 204A to complete the processing of the blink signal 208 and then transmit a notification 210A to the reference AP 202. Similarly, the second anchor 204B and the third anchor 204C may also receive the blink signal 208, record their respective ToA timestamps (e.g., “T2” and “T3”), and take the processing time duration of tₚ² and tₚ³ respectively to process the blink signal 208 before transmitting respective notifications 210B and 210C to the reference AP 202. These set of notifications 210A, 210B, 210C transmitted by the anchors 204A-C, respectively, may be utilized for TDoA estimation of the blink signal 208 at the reference AP 202. Each of the set of notifications 210A, 210B, 210C may include the processing time duration recorded by respective anchors 204A-C and can optionally include ToA data. The set of notifications 210A, 210B, 210C may be transmitted from the respective anchors 204A-C to the reference AP 202 by way of a wireless or wired communication channel, depending on the network setup. In many deployments, anchors communicate with a reference AP over a wireless network, such as Wi-Fi, UWB, or another low-latency wireless protocol. In yet various embodiments, the set of notifications 210A, 210B, 210C may be transmitted using standard wireless frames or packets over a pre-configured channel, ensuring they reach the reference AP 202 without significant delays.

When anchors transmit notifications without synchronized timing, there is a high probability of message collisions at a receiving end. This may occur as the interval between arrival times of the notifications at the reference AP 202 is often shorter than the frame duration each notification. In other words, if an i^{th} anchor transmits a notification immediately after processing a received blink signal, and there is no predetermined sequence or timing, all anchors may end up transmitting their notifications at nearly the same time. Further, if the interval between the arrival times of the notifications is shorter than the frame duration, it becomes likely that the notifications will overlap and collide at the receiving end. Therefore, in still further embodiments, the reference AP 202 or a network controller/admin may assign a priority order to the anchors 204A-C. In still various embodiments, the priority order may be assigned based on respective distance of the anchors 204A-C from the reference AP 202. Thus, an anchor that is nearest to the reference AP 202 may be assigned the highest priority. Likewise, another anchor that is farthest from the reference AP 202 may be assigned the lowest priority. For example, if the first anchor 204A is nearest to the reference AP 202, the first anchor 204A can be assigned the highest priority. The second anchor 204B may be assigned the second highest priority while the third anchor 204C may have the least priority in the priority order based on the proximity of the second anchor 204B and the third anchor 204C with the reference AP 202. In still additional embodiments, the anchors 204A-C may transmit the set of notifications 210A, 210B, 210C sequentially based on the priority order to prevent any collision at the reference AP 202.

In numerous embodiments, the reference AP 202 may also be configured to receive the blink signal 208 transmitted by the tag 206. For example, the reference AP 202 may receive the blink signal 208 within a time duration of T=t₄ from the time instance the blink signal 208 was emitted by the tag 206. Further, the reference AP 202 may record, with reference to the clock of the reference AP 202, a local arrival timestamp “T4” of the blink signal 208 at the reference AP 202. The reference AP 202 may be further configured to receive the set of notifications 210A, 210B, 210C from the anchors 204A-C. For example, the reference AP 202 may receive the set of notifications 210A, 210B, 210C sequentially based on the priority order. That is to say, the reference AP 202 may receive the notification 210A from the first anchor 204A, followed by the notification 210B from the second anchor 204B, and lastly the notification 210C from the third anchor 204C.

In still further embodiments, the reference AP 202 may be further configured to record respective first arrival timestamps of the set of notifications 210A, 210B, 210C. The first arrival timestamp of a notification may correspond to a ToA of the notification at the reference AP 202 recorded with reference to the clock of the reference AP 202. In other words, the reference AP 202 may record the respective first arrival timestamps of the set of notifications 210A, 210B, 210C at the reference AP 202. In still yet various embodiments, the reference AP 202 may be configured to determine a travel time duration “t_{D} ⁱ” associated with each of the set of notifications 210A, 210B, 210C. The travel time duration “t_{D} ⁱ” may correspond to the time it takes for a notification to reach the reference AP 202 from a corresponding anchor (e.g., any of the anchors 204A-C). The travel time duration “t_{D} ⁱ” may be determined based on the known location of the anchors 204A-C and the distances between the anchors 204A-C and the reference AP 202. For example, if the speed of travel of a notification from an i^{th} anchor is assumed to be “c” (e.g., the speed of light) and the known distance between the i^{th} anchor and the reference AP 202 is “dᵢ”, the travel time duration “t_{D} ⁱ” may be determined as dᵢ/c.

There is often a delay or latency associated with the process of the reference AP 202 receiving the set of notifications 210A, 210B, 210C from the anchors 204A-C. This latency might be due to communication delays, the processing time, or the travel time durations. In a variety of embodiments, the reference AP 202 may be further configured to assess a latency value for each notification of the set of notifications 210A, 210B, 210C based on the processing time duration and the travel time duration associated with the corresponding notification. That is, the latency value may be represented as t_{L}ⁱ, where t_{L}ⁱ=tₚⁱ+t_{D}ⁱ+Δt. Δt can be any other delay associated with the notification.

Upon determining the first arrival timestamps and the latency values for the set of notifications 210A, 210B, 210C, in additional embodiments, the reference AP 202 may be configured to determine respective second arrival timestamps of the blink signal 208 at the anchors 204A-C with reference to the clock of the reference AP 202. In other words, the reference AP 202 may utilize the first arrival timestamps recorded with reference to the clock of the reference AP 202 and the latency values to determine the respective second arrival timestamps of the blink signal 208 at the anchors 204A-C. In an example, the second arrival timestamp of the blink signal 208 at the first anchor 204A may be determined based on a function of the first arrival timestamp associated with the notification 210A and the latency value t_{L}¹ assessed for the notification 210A. Here, the function may be a difference function. Thus, the second arrival timestamp of the blink signal 208 at the first anchor 204A may be determined by subtracting the latency value t_{L}¹ assessed for the notification 210A from the first arrival timestamp associated with the notification 210A. Likewise, the respective second arrival timestamps of the blink signal 208 at the second anchor 204B and the third anchor 204C are also determined. Notably, by utilizing the clock of the reference AP 202 for recording the first arrival timestamps of the set of notifications 210A, 210B, 210C and assessing the latency values of the set of notifications 210A, 210B, 210C, the reference AP 202 is able to estimate when the blink signal 208 actually arrived at the anchors 204A-C in terms of the clock of the reference AP 202. Thus, eliminating the dependency on clock synchronization between the local clocks of the anchors 204A-C and the clock of the reference AP 202.

In further embodiments, the reference AP 202 may be further configured to identify a plurality of device pairs. A device pair of the plurality of device pairs may include one of: a combination of the reference AP 202 and any of the anchors 204A-C or a combination of any two anchors from the anchors 204A-C. In an example embodiment as shown in FIG. 2, the reference AP 202 and any of the anchors 204A-C can form a device pair. Additionally, the anchors 204A-C can also form device pairs in various combinations. The reference AP 202 may be configured to estimate, for each device pair, a TDoA for the blink signal 208 based on the clock of the reference AP 202 and the assessed latency values of the set of notifications 210A, 210B, 210C. In one or more embodiments, the reference AP 202 may be configured to wait until the reference AP 202 receives the notification from the last AP in the priority order or until a defined time duration of receiving the notification from the last AP expires, for TDoA estimation.

In an example embodiment, the TDoA of the blink signal 208 for a device pair including the reference AP 202 and the first anchor 204A may be estimated as a function of the local arrival timestamp of the blink signal 208 at the reference AP 202 and the second arrival timestamp of the blink signal 208 at the first anchor 204A. Here, the function may be a difference function. For example, the TDoA of the blink signal 208 for the device pair including the reference AP 202 and the first anchor 204A may be estimated as a difference between the local arrival timestamp of the blink signal 208 at the reference AP 202 and the second arrival timestamp of the blink signal 208 at the first anchor 204A. Using the same function, the reference AP 202 may estimate the TDoAs for remaining device pairs including the reference AP 202 and the second anchor 204B, and the reference AP 202 and the third anchor 204C. In further example, the TDoA of the blink signal 208 for a device pair including the first anchor 204A and the second anchor 204B may be estimated as a function of the second arrival timestamp of the blink signal 208 at the first anchor 204A and the second arrival timestamp of the blink signal 208 at the second anchor 204B. Here, the function may be a difference function. For example, the TDoA of the blink signal 208 for the device pair including the first anchor 204A and the second anchor 204B may be estimated as a difference between the two second arrival timestamps. Using the same function, the reference AP 202 may estimate the TDoAs for remaining device pairs including the second anchor 204B and the third anchor 204C, and the first anchor 204A and the third anchor 204C. Thus, TDoA data estimated by the reference AP 202 is in terms of the timings recorded by the clock of the reference AP 202. In other words, synchronization of the local clocks of the anchors 204A-C with the clock of the reference AP 202 for TDoA estimation can thus be avoided.

In some more embodiments, the reference AP 202 may be further configured to determine a location of the tag 206 based on the estimated TDoA associated with each device pair of the plurality of device pairs. In yet more embodiments, the reference AP 202 may be configured to consider that the blink signal 208 has not been received by an anchor if a notification from the anchor is not received as per the priority order. Further, the TDoA data may be utilized by the reference AP 202 to solve a set of non-linear equations (e.g., hyperbolic equations) to obtain a set of hyperbolas 212A, 212B, 212C. The “hyperbolas” may refer to geometric curves representing possible tag locations. The set of hyperbolas 212A, 212B and 212C may be utilized to determine the precise location of the tag 206. An intersection 214 of the set of hyperbolas 212A, 212B, 212C may represent the estimated location of the tag 206. The estimated location may be updated in real-time as the tag 206 continues to move and emit new blink signals. The reference AP 202 may keep tracking the movement of the tag 206 and can display the determined locations on a map or transmit location data to other systems.

In several additional embodiments, the set of notifications 210A, 210B, 210C may further include ToAs of the blink signal 208 as recorded based on the local clocks of the respective anchors 204A-C. In order to expedite device localization of the tag 206 for subsequent blink signals after device localization is once performed for the blink signal 208, the reference AP 202 may be configured to utilize the ToAs included in the set of notifications 210A, 210B, 210C and the second arrival timestamps determined by the reference AP 202 to determine clock offsets between the clock of the reference AP 202 and the local clocks of the respective anchors 204A-C. For example, if the reference AP 202 determines that an offset between the ToA included in the notification 210A and the second arrival timestamp of the blink signal at the first anchor 204A is 2 nanoseconds (ns), the next time the reference AP 202 receives a notification including a ToA from the first anchor 204A, the reference AP 202 may determine a new second arrival timestamp by correcting the ToA with the determined clock offset of 2 ns. Thus, the anchors 204A-C may not need to include the processing time durations in subsequent notifications for at least a predefined time period and TDoA estimation for subsequent blink signals can be expedited.

Although a specific embodiment for the example network 200 suitable for carrying out the various steps, processes, methods, and operations described herein is discussed with respect to FIG. 2, any of a variety of systems and/or processes may be utilized in accordance with embodiments of the disclosure. For example, a plurality of anchors may belong to a multi-cluster network, and each network cluster may be managed by a separate reference AP. Thus, in many further embodiments, an anchor belonging to multiple network clusters may transmit a notification to all reference APs that manage these multiple network clusters upon arrival of the blink signal at the anchor. The elements depicted in FIG. 2 may also be interchangeable with other elements of FIG. 1 and FIGS. 3-10 as required to realize a particularly desired embodiment.

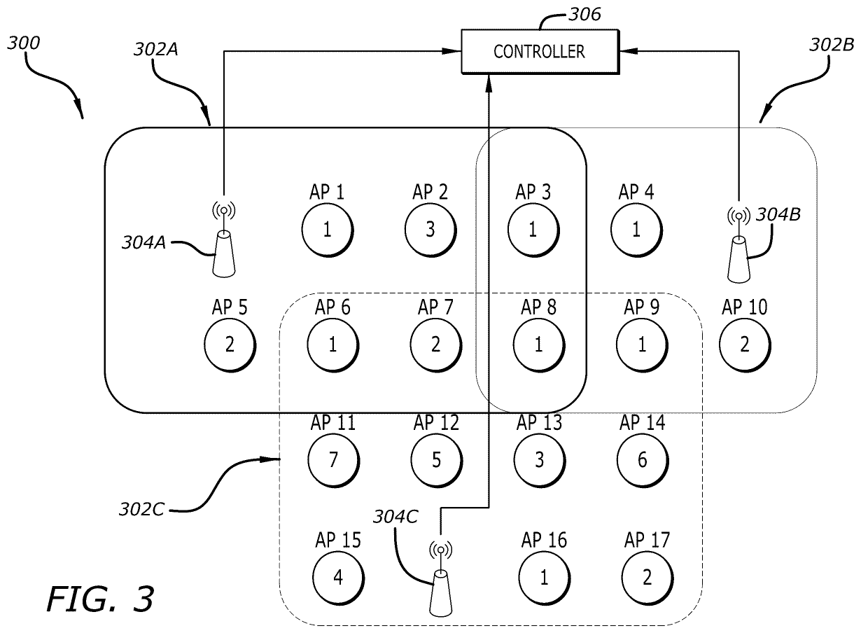

Referring to FIG. 3, a conceptual diagram of an example multi-cluster network 300 facilitating device localization independent of clock synchronization in accordance with various embodiments of the disclosure is shown. The network 300 may correspond to a wireless multi-cluster network architecture that may include a plurality of network clusters. In an example embodiment shown in FIG. 3, the multi-cluster network 300 may include at least three network clusters such as a first network cluster 302A, a second network cluster 302B, and a third network cluster 302C (hereinafter, collectively referred to as “the network clusters 302A-C”). A “network cluster” may refer to a group of network devices that are managed by a specific reference AP. Thus, each of the network clusters 302A-C may be managed by a designated reference AP responsible for localizing one or more wireless transceivers associated with mobile devices (e.g., tags) within its area. That is to say, the first network cluster 302A may be managed by a first reference AP 304A, the second network cluster 302B may be managed by a second reference AP 304B, and the third network cluster 302C may be managed by a third reference AP 304C. In many embodiments, each of the first through third reference APs 304A-C may be configured with a clock, either internally or externally coupled. The “clock” may include suitable logic, circuitry, and/or interfaces to execute a precise timing mechanism or oscillator that keeps track of time within the first through third reference APs 304A-C. Further, each of the first through third reference APs 304A-C may be coupled to a controller 306. The controller 306 may include suitable logic, circuitry, and/or interfaces to execute a localization of the one or more tags. The controller 306 may further include a processor, a transceiver, and a memory communicatively coupled to the processor to facilitate localization of the one or more tags. In a number of embodiments, the controller 306 may be further equipped with a localization logic (for example, stored in the memory or implemented as a hardware component in the controller 306).

Each of the network clusters 302A-C may further include a plurality of peer devices (e.g., network devices, secondary APs, or anchors or the like). In the example scenario illustrated in FIG. 3, the multi-cluster network 300 is shown to include 17 anchors, for example, AP 1-AP 17 distributed across the network clusters 302A-C. The first network cluster 302A, managed by the first reference AP 304A is shown to include seven anchors such as AP 1-AP 3 and AP 5-AP 8, and the second network cluster 302B, managed by the second reference AP 304B, is shown to include five anchors such as AP 3, AP 4, and AP 8-AP 10, for example. Further, the third network cluster 302C, managed by the third reference AP 304C is shown to include 11 anchors such as AP 6-AP 9 and AP 11-AP 17, for example. As can be seen, AP 3 belongs to both first and second network clusters 302A and 302B, AP 6-AP 7 also belong to two network clusters 302A and 302C. Further, AP 9 belongs to the second and third network clusters 302B and 302C, while AP 8 belongs to all three network clusters 302A-C.

When a tag emits a blink signal, the blink signal may be received by AP 1-AP 17, including the first through third reference APs 304A-C. In other words, the blink signal arrives at AP 1-AP 17, spread across different network clusters 302A-C. When AP 1-AP 17 receive the blink signal, AP 1-AP 17 may record, with reference to respective local clocks, a ToA of the blink signal and processing time duration of the blink signal. AP 1-AP 17 may then transmit respective notifications indicating an arrival and the processing time duration of the blink signal to the associated first through third reference APs 304A-C.

In still further embodiments, the first through third reference APs 304A-C may receive a set of notifications from respective anchors (e.g., AP 1-AP 17). Each of the first through third reference APs 304A-C associated with a particular network cluster may estimate a TDoA for each device pair in the particular network cluster. For example, the first reference AP 304A may estimate a TDoA for each device pair in the first network cluster 302A based on the clock of the first reference AP 304A and a latency value associated one or two anchors in the device pair.

In still yet further embodiments, the first through third reference APs 304A-C may transmit the estimated TDoAs to the controller 306 coupled to the first through third reference APs 304A-C. In still yet more embodiments, the controller 306 may be configured to aggregate TDoAs of all device pairs in the network clusters 302A-C to obtain intersecting hyperbolas. That is to say, for every device pair in the network clusters 302A-C, a hyperbola is created using corresponding TDoA data. A “hyperbola” represents all possible points where the tag could be located based on the difference in distances from the two devices in the device pair. With anchors spread across multiple network clusters, there are more device pairs, resulting in a greater number of hyperbolas being generated. The intersecting hyperbolas indicate the location of the tag. As the number of hyperbolas increases, the potential region where all hyperbolas intersect becomes smaller and more precise. This intersection may represent the most likely location of the tag. A higher number of hyperbolas may reduce the ambiguity in localization because the overlapping areas become narrower. Consequently, the feasible set of possible locations is minimized, thereby increasing the accuracy and reliability of the position estimation.

In various embodiments, the anchors (e.g., AP 1-AP 17) may transmit the respective notifications based on an assigned priority order. The assigned priority order may be based on a count of clusters an anchor is associated with and a distance between an anchor and corresponding reference AP(s). In many additional embodiments, the priority order may be segregated into a number of stages of transmission depending on multi-cluster associations. For example, anchors belonging to a single cluster may be assigned to a first stage of transmission, anchors belonging to two clusters may be assigned to a second stage of transmission, anchors belonging to three clusters may be assigned to a third stage of transmission, and so on. In other words, those anchors that are associated with the least count of network clusters may be assigned to the first stage of transmission. The anchors within a particular stage may be further assigned priorities based on a distance between the anchor and the corresponding reference AP(s). Thus, the anchor closest to the reference AP may be assigned the highest priority within the respective stage.

For example, AP 1, AP 2, and AP 5 are associated with only one cluster 302A managed by the first reference AP 304A. Thus, the AP 1, AP 2, and AP 5 may belong to the first stage of transmission. In a scenario where AP 1 is closest to the first reference AP 304A, AP 5 is the second closest to the first reference AP 304A, and AP 2 is farthest from the first reference AP 304A, AP 1 may be assigned the highest priority “1”, AP 5 the second highest priority “2”, and AP 2 the lowest priority “3” within the first stage of transmission. Further, AP 4 and AP 10 are associated with only one cluster 302B managed by the second reference AP 304B. Thus, AP 4 and AP 10 may also belong to the first stage of transmission. In a scenario where AP 4 is closest to the second reference AP 304B and AP 10 is farthest from the second reference AP 304B, AP 4 may be assigned the highest priority “1” and AP 10 the lowest priority “2” within the first stage of transmission. In yet various embodiments, anchors that are associated with non-overlapping reference APs can be assigned same priority as there is no likelihood of collision. For example, AP 1 and AP 4 can be assigned the same priority “1” within the first stage of transmission as AP 1 and AP 4 are associated with non-overlapping reference APs 304A and 304B. Likewise, AP 16, AP 17, AP 13, AP 15, AP 12, AP 14, and AP 11 having single cluster association are also assigned to the first stage of transmission with respective priorities a {1-7} based on the distance from the third reference AP 304C. Further, AP 3, AP 6, AP 7, and AP 9 having dual cluster association are sorted in priorities {1, 1, 2, 1} within the second stage of transmission based on distances from the associated first through third reference APs 304A-C and non-overlapping reference AP associations. Further, AP 8 having three cluster association is assigned a priority “1” in the third stage of transmission.

Thus, as per the assigned priority order, anchors within the first stage of transmission may transmit notifications before those in the second stage of transmission and anchors within the second stage of transmission may transmit notifications before those in the third stage of transmission. Within each stage of transmission, anchors transmit notifications sequentially, according to assigned priorities within the respective stage. In still various embodiments, AP 1-AP 17 may transmit respective notifications sequentially as per the assigned stage of transmission and the priority order within the respective stage of transmission. Thus, the first through third reference APs 304A-304C may receive a set of notifications from AP 1-AP 17 based on the distance or travel delay between anchor-reference AP pair.

Although a specific embodiment for illustrating an example multi-cluster network 300 facilitating device localization independent of clock synchronization suitable for carrying out the various steps, processes, methods, and operations described herein is discussed with respect to FIG. 3, any of a variety of systems and/or processes may be utilized in accordance with embodiments of the disclosure. In many non-limiting examples, the determination of priority order may be based on different factors such as transmission delays between the anchors and the reference AP, device characteristics of the anchors, or the like. The elements depicted in FIG. 3 may also be interchangeable with other elements of FIGS. 1-2 and FIGS. 4-10 as required to realize a particularly desired embodiment.

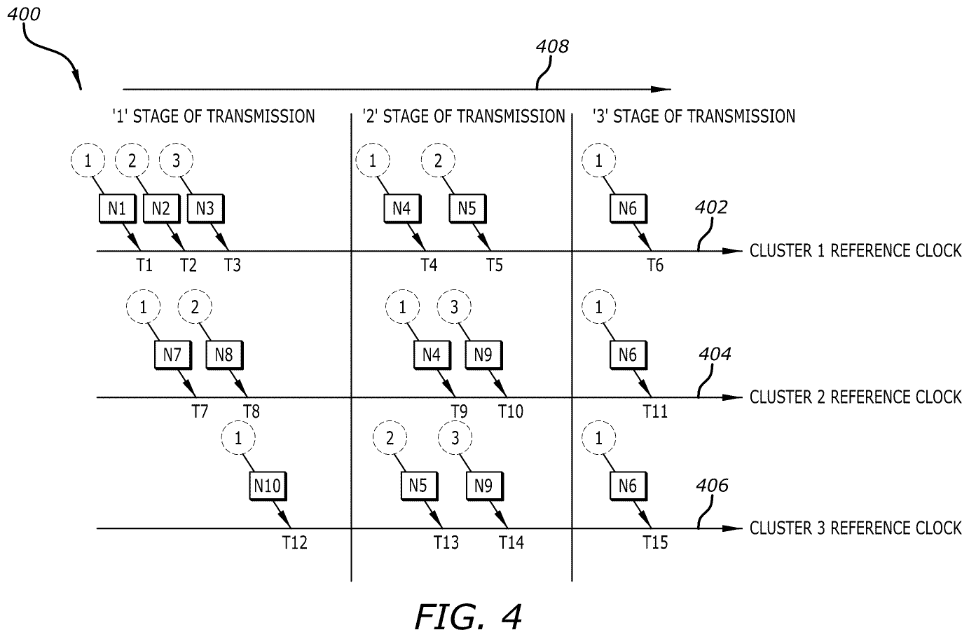

Referring to FIG. 4, a conceptual diagram 400 representing priority based ToAs of a set of notifications in a multi-cluster network scenario in accordance with various embodiments of the disclosure is shown. For the sake of brevity, a multi-network cluster comprising three network clusters associated with three reference APs are considered in the example shown in FIG. 4. Each anchor in the multi-network cluster may belong to one or more network clusters. Further, each reference AP may be associated with a clock based on which TDoA is estimated. For example, a first reference AP associated with a first network cluster (referred to as “cluster 1” in FIG. 4) may have a first reference clock 402. Similarly, a second reference AP associated with a second network cluster (referred to as “cluster 2” in FIG. 4) may have a second reference clock 404. A third reference AP associated with a third network cluster (referred to as “cluster 3” in FIG. 4) may have a third reference clock 406.

The multi-network cluster may include a plurality of anchors, each associated with one, two, or all three network clusters. That is to say, each anchor may belong to one, two, or three network clusters. Thus, the anchors belonging to a single network cluster may be grouped under ‘1’ cluster association, the anchors belonging to two network clusters may be grouped under ‘2’ cluster association, and the anchors belonging to three network clusters may be grouped under ‘3’ cluster association. Further, the plurality of anchors may be segregated into a plurality of stages of transmissions as per their cluster associations. The plurality of stages of transmissions are sorted in a priority order. In the current example, a first stage of transmission having anchors with a single cluster association has the highest priority, a second stage of transmission having anchors with dual cluster association has the second highest priority, and a third stage of transmission having anchors with three cluster association has the lowest priority. In other words, the anchors with the least number of cluster associations may be scheduled first for transmission, while the anchors with the highest number of cluster associations may be scheduled last for transmission. Further, within each stage of transmission, the anchors are sorted in a priority order as per their distance from corresponding reference APs, where higher the distance lower the priority.

In numerous embodiments, the reference APs associated with the multi-network cluster may be configured to receive a set of notifications from respective anchors based on the priority order. Arrow 408 shown in FIG. 4 represents a decreasing priority order. In the example embodiment shown in FIG. 4, anchors grouped under ‘1’ stage of transmission, transmit their notifications to their corresponding reference APs based on the priority order within the ‘1’ stage of transmission. Thus, based on the priorities “1”, “2”, and “3”, the first reference AP may sequentially receive notifications N1, N2, and N3 at timestamps T1, T2, and T3 of the first reference clock 402, where T3>T2 >T1. Further, based on the priorities “1” and “2”, the second reference AP may sequentially receive notifications N7 and N8 at timestamps T7 and T8 of the second reference clock 404, where T8>T7. Similarly, the third reference AP may receive a notification N10 at a timestamp T12 of the third reference clock 406.

Continuing the example embodiment shown in FIG. 4, anchors grouped under ‘2’ stage of transmission, transmit their notifications to their corresponding reference APs based on the priority order within the ‘2’ stage of transmission. Thus, based on the priorities “1” and “2”, the first reference AP may sequentially receive notifications N4 and N5 at timestamps T4 and T5 of the first reference clock 402, where T5>T4. Further, the second reference AP may also sequentially receive notifications N4 and N9 at timestamps T9 and T10 of the second reference clock 404, where T10 >T9. Similarly, the third reference AP may receive notifications N5 and N9 at timestamps T13 and T14 of the third reference clock 406, where T14>T13.

Further continuing the example embodiment shown in FIG. 4, anchors grouped under ‘3’ stage of transmission, transmit their notifications to their corresponding reference APs based on the priority order within the ‘3’ stage of transmission. In the current example, only one anchor is included in the 3′ stage of transmission. Thus, the first reference AP may receive a notification N6 at a timestamps T6 of the first reference clock 402. The second reference AP may also receive the notification N6 at a timestamp T11 of the second reference clock 404. Similarly, the third reference AP may receive the notifications N6 at a timestamp T15 of the third reference clock 406.

Although a specific embodiment for depicting priority based ToAs of a set of notifications in a multi-cluster network scenario suitable for carrying out the various steps, processes, methods, and operations described herein is discussed with respect to FIG. 4, any of a variety of systems and/or processes may be utilized in accordance with embodiments of the disclosure. For example, the multi-network cluster may include N number of network clusters, where N is any integer >1. The notifications from the anchors belonging to such a multi-network cluster may be transmitted in N stages. The transmission of notifications from the anchors belonging to N network clusters may be in the N^{th} stage of transmission. The elements depicted in FIG. 4 may also be interchangeable with other elements of FIGS. 1-3 and 5-10 as required to realize a particularly desired embodiment.

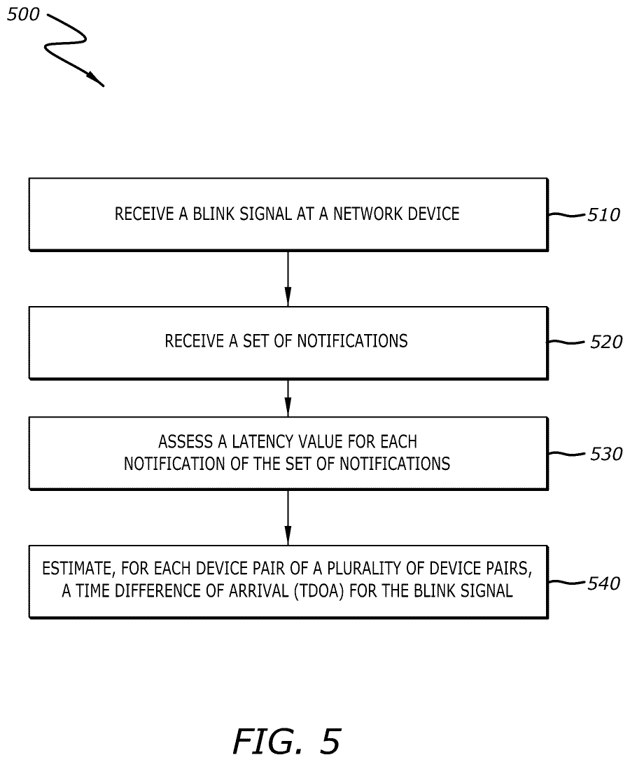

Referring to FIG. 5, a flowchart showing a process 500 for estimation of TDoA independent of clock synchronization for a single network cluster in accordance with various embodiments of the disclosure is shown. In many embodiments, the process 500 may receive a blink signal at a network device (block 510). In an example, the network device may be a reference AP in the network cluster. The reference AP may act as a central processing hub performing the process 500 to determine a location of the wireless transceiver. The network cluster may further include a plurality of peer devices (e.g., anchors, secondary APs, or the like). In various embodiments, the blink signal may be received from a wireless transceiver within the network. The wireless transceiver may transmit the blink signal for localization. The plurality of peer devices within the network may also receive the blink signal, process the blink signal for ToA estimation, and subsequently may transmit a set of notifications indicating an arrival and a processing time duration of the blink signal to the network device.

In a number of embodiments, the process 500 may receive the set of notifications (block 520). Each of the set of notifications may be configured to indicate the arrival and the processing time duration of the blink signal to the network device at a corresponding peer device. For example, if the process 500 receives a notification from a first peer device, the notification may indicate an arrival and a processing time duration of the blink signal at the first peer device.

In a variety of embodiments, the process 500 may assess a latency value for each notification of the set of notifications (block 530). There is often a delay or latency associated with the process of receiving the set of notifications from the plurality of peer devices. The latency might be due to communication delays, processing time, travel time durations, or network transmission time. The process 500 may assess the latency value for each notification of the set of notifications based on the processing time duration and a travel time duration associated with the corresponding notification. For example, the latency value for an i^{th} notification may be represented as t_{L}ⁱ, where t_{L}ⁱ=tₚⁱ+t_{D}ⁱ+Δt. Here, tₚⁱ may represent a processing time duration of the blink signal at an i^{th} peer device that transmitted the i^{th} notification, t_{D}ⁱ may represent the travel time duration of the i^{th} notification from the i^{th} peer device to the network device, and Δt can be any other delay associated with the i^{th} notification.

In still additional embodiments, the process 500 may estimate, for each device pair of a plurality of device pairs, a TDoA for the blink signal (block 540). In various embodiments, for each device pair of the plurality of device pairs, the TDoA for the blink signal may be estimated based on a clock of the network device and respective assessed latency value. In further embodiments, a “device pair” may include one of a combination of the network device and a peer device of the plurality of peer devices or a combination of two peer devices of the plurality of peer devices. For example, the TDoA of the blink signal for a device pair including the network device and the i^{th} peer device may be estimated based on the clock of the network device and the assessed latency value associated with the i^{th} notification transmitted by the i^{th} peer device. Similarly, the TDoA of the blink signal for a device pair including the i^{th} peer device and a j^{th} peer device may be estimated based on the clock of the network device and the assessed latency values associated with the i^{th} notification and a j^{th} notification transmitted by the j^{th} peer device. In other words, estimating the TDoA for the blink signal is independent of clock synchronization between the network device and the plurality of peer devices. In numerous embodiments, by comparing the TDoAs associated with multiple device pairs, the process 500 can triangulate the location of the wireless transceiver.

Although a specific embodiment for estimation of TDoA for a single network cluster suitable for carrying out the various steps, processes, methods, and operations described herein is discussed with respect to FIG. 5, any of a variety of systems and/or processes may be utilized in accordance with embodiments of the disclosure. For example, the process 500 may be performed by an RTLS that performs localization of tags in a given area. The elements depicted in FIG. 5 may also be interchangeable with other elements of FIGS. 1-4 and 6-10 as required to realize a particularly desired embodiment.

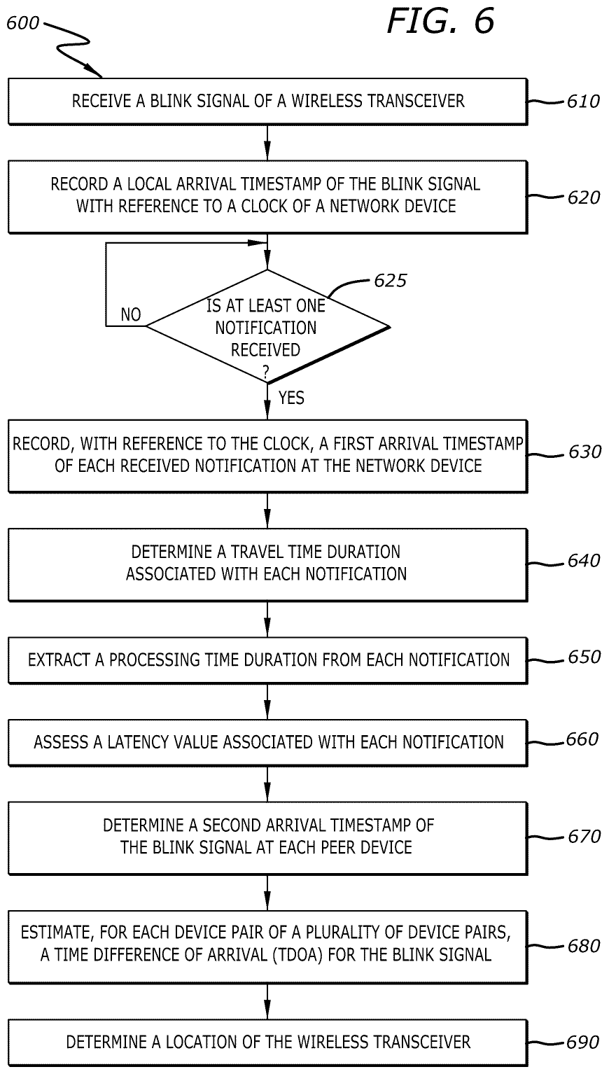

Referring to FIG. 6, a flowchart showing a process 600 for estimation of TDoA without clock synchronization in accordance with various embodiments of the disclosure is shown. The process 600 may be performed at a network device (e.g., a master AP, a primary AP, a reference AP, or the like) associated with a network cluster comprising a plurality of peer devices (e.g., secondary APs, slave APs, anchors, or the like). The network device may be configured to manage the network cluster. In many embodiments, the process 600 may receive a blink signal of a wireless transceiver (block 610). The wireless transceiver may be associated with a mobile device, an asset, an object, an individual, etc. that requires tracking or location detection. The wireless transceiver can be an IoT sensor, a UWB tag, an RFID tag, or another type of wireless transceiver depending on requirements associated with a system. The wireless transceiver may periodically or randomly (or when triggered) emit a signal, often referred to as a “blink.” The blink signal may be received by the plurality of peer devices in the network cluster. In other words, the blink signal may be a single, brief transmission intended to be received by the plurality of peer devices and the network device that may be configured to manage the network cluster.

In a number of embodiments, the process 600 may record a local arrival timestamp of the blink signal with reference to a clock of the network device (block 620). The clock may be equipped in the network device or may be externally coupled to the network device. The “clock” may include suitable logic, circuitry, and/or interfaces to execute a precise timing mechanism or oscillator that keeps track of time within the network device. The clock may be configured to measure the exact timestamp (e.g. the local arrival timestamp) at which the blink signal from the wireless transceiver is received at the network device.

In a variety of embodiments, the process 600 may determine if at least one notification is received (block 625). The at least one notification may be received from a peer device of the plurality of peer devices in the network cluster. The plurality of peer devices may be anchors with known locations in the given area. In other words, the plurality of peer devices may be fixed reference points placed strategically within the given area to device localization. A peer device, upon receiving the blink signal, may be configured to process the blink signal, record a processing time duration required to process the blink signal, and transmit a notification to the network device. The notification may indicate an arrival and the processing time duration of the blink signal at the peer device. The process 600 may thus receive the notification from the peer device. The notification can be utilized for TDoA estimation of the blink signal at the network device and the peer device.

If no notification is received, in various embodiments, the process 600 may keep checking for receipt of notifications from one or more peer devices in the network cluster (block 625). However, if the at least one notification is received, in numerous embodiments, the process 600 may record, with reference to the clock, a first arrival timestamp of each received notification at the network device (block 630). That is to stay, the process 600 may keep recording the first arrival timestamp for every notification that the process 600 receives. In other words, the process 600 may refer to the clock and log the timestamp indicated by the clock when each notification is received as the first arrival timestamp.

In several embodiments, the process 600 may determine a travel time duration associated with each notification (block 640). The “travel time duration” may refer to the time a notification may take to reach the network device from a corresponding peer device. The travel time duration may be determined based on the known location of the peer device and the distance between the peer device and the network device. For example, if the peer device is located 300 meters from the network device, and assumingly that the notification travels at a speed of light, the travel time duration can be determined as 1 microsecond (1 μs). For a different distance, say 150 meters, the travel time duration would be determined as 0.5 microseconds (0.5 μs).

In further embodiments, the process 600 may extract the processing time duration from each notification (block 650). Each peer device may be configured to process the blink signal before transmitting information associated with the blink signal as part of the notification to the network device. That is to say, the processing time duration of the blink signal that the peer device has included in the notification is identified and then extracted by the process 600 to determine an accurate ToA of the blink signal at the peer device with reference to the clock of the network device.

In still more embodiments, the process 600 may assess a latency value associated with each notification (block 660). There is often a delay or latency associated with the process of the network device receiving the notification from the peer devices. This latency might be due to communication delays, processing time duration, travel time duration, or network transmission time. Thus, the process 600 may assess the latency value for each notification based on the processing time duration and the travel time duration associated with the corresponding notification in order to determine an accurate ToA of the blink signal at the corresponding peer device. For example, the latency value for an i^{th} notification may be represented as t_{L}ⁱ, where t_{L}ⁱ=tₚⁱ+t_{D}ⁱ+Δt. Here, tₚⁱ may represent a processing time duration of the blink signal at an i^{th} peer device that transmitted the i^{th} notification, t_{D}ⁱ may represent the travel time duration of the i^{th} notification from the i^{th} peer device to the network device, and Δt can be any other delay associated with the i^{th} notification.

In still yet more embodiments, the process 600 may determine a second arrival timestamp of the blink signal at each peer device (block 670). The second arrival timestamp of the blink signal at the peer device may be determined based on the first arrival timestamp and the assessed latency value associated with the notification. In an example, the second arrival timestamp of the blink signal at the i^{th} peer device may be determined based on a function of the first arrival timestamp associated with the i^{th} notification and the latency value t_{L}ⁱ assessed for the i^{th} notification. Here, the function may be a difference function. Thus, the second arrival timestamp of the blink signal at the i^{th} peer device may be determined by subtracting the latency value t_{L}ⁱ assessed for the i^{th} notification from the first arrival timestamp associated with the i^{th} notification. Notably, by utilizing the clock of the network device for recording the first arrival timestamps of received notifications and assessing the latency values of the notifications, the process 600 is able to estimate when the blink signal actually arrived at corresponding peer devices in terms of the clock of the network device. Thus, eliminating the dependency on clock synchronization between local clocks of the peer devices and the clock of the network device.

In still additional embodiments, the process may estimate, for each device pair of a plurality of device pairs, a TDoA for the blink signal (block 680). The process 600 may estimate the TDoA for the blink signal for each device pair based on the clock and the assessed latency value. A “device pair” of the plurality of device pairs may include one of a combination of the network device and a peer device of the plurality of peer devices from which the notification(s) are received or a combination of two peer devices of the plurality of peer devices. In an example embodiment, the TDoA of the blink signal for a device pair including the network device and a peer device may be estimated as a function of the local arrival timestamp and the second arrival timestamp. Here, the function may be a difference function. For example, the TDoA of the blink signal for the device pair including the network device and the i^{th} peer device may be estimated as a difference between the local arrival timestamp of the blink signal at the network device and the second arrival timestamp of the blink signal at the i^{th} peer device. In additional example embodiment, the TDoA of the blink signal for a device pair including two peer devices (e.g., the i^{th} peer device and a j^{th} peer device) may be estimated as a function of the second arrival timestamps of the blink signal at respective i^{th} and j^{th} peer devices. Here, the function may be a difference function. For example, the TDoA of the blink signal for the i^{th} and j^{th} peer devices may be estimated as a difference between the second arrival timestamps of the blink signal at the i^{th} and j^{th} peer devices. In a non-limiting example, suppose the network device receives a first notification from a first peer device at 10:00:05.100 (i.e., first arrival timestamp of the first notification) and a second notification from a second peer device at 10:00:05.300 (i.e., first arrival timestamp of the second notification). If the assessed latency value for the first notification is 1 millisecond (ms), the second arrival timestamp of the blink signal at the first peer device can be determined as 10:00:05.099. Similarly, if the assessed latency value for the second notification is 2 ms, the second arrival timestamp of the blink signal at the second peer device is 10:00:05.298. Thus, the TDoA for this device pair may be estimated as the difference between the two second arrival timestamps: 10:00:05.298−10:00:05.099=199 ms. Thus, TDoA for each device pair of the plurality of device pairs may be estimated independently of whether the plurality of peer devices is clock synchronized with the clock of the network device.

In still further embodiments, the process 600 may determine a location of the wireless transceiver (block 690). The process 600 may determine the location of the wireless transceiver (e.g., the tag) based on the estimated TDoAs of the plurality of device pairs. In other words, the process 600 may aggregate all TDoAs from all device pairs to form a set of non-linear equations (e.g., hyperbolic equations). By solving the set of hyperbolic equations, the process 600 may generate a set of intersecting hyperbolas. That is to say, for every device pair in the network particular cluster, a hyperbola is generated using the TDoA data that may represent all possible points where the wireless transceiver could be located. With device pairs spread across the network cluster, a greater number of hyperbolas may be generated. The point or an area where the hyperbolas intersect may indicate the location of the wireless transceiver.

Although a specific embodiment for estimation of TDoA without clock synchronization suitable for carrying out the various steps, processes, methods, and operations described herein is discussed with respect to FIG. 6, any of a variety of systems and/or processes may be utilized in accordance with embodiments of the disclosure. For example, the process 600 may determine the location of a plurality of wireless transceivers and subsequent tracking of the plurality of wireless transceivers roaming in the area. The elements depicted in FIG. 6 may also be interchangeable with other elements of FIGS. 1-5 and FIGS. 7-10 as required to realize a particularly desired embodiment.

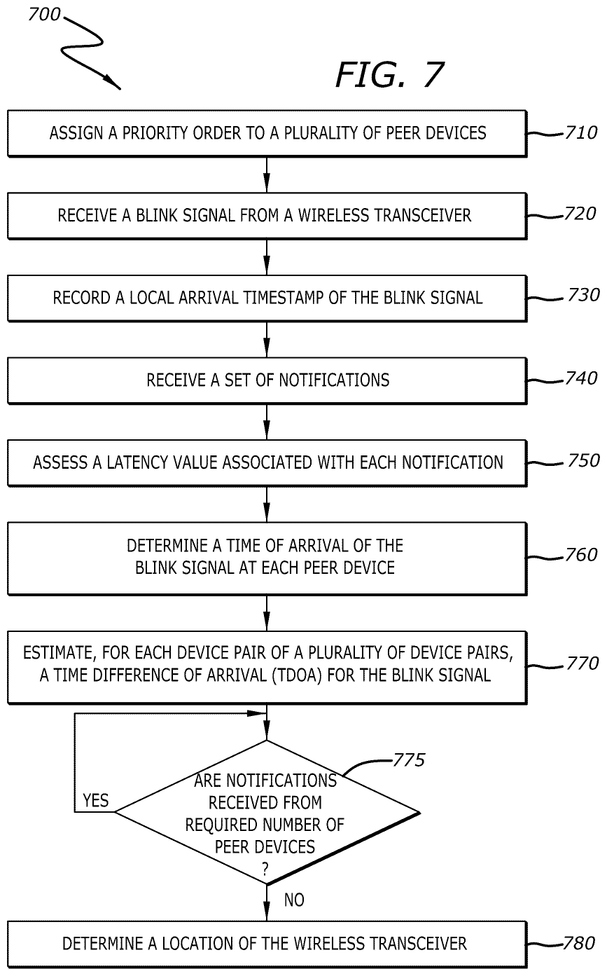

Referring to FIG. 7, a flowchart showing a process 700 for estimation of TDoA based on a priority order in accordance with various embodiments of the disclosure is shown. The process 700 may be performed at a network device (e.g., a master AP, a primary AP, a reference AP or the like) associated with a network cluster comprising a plurality of peer devices (e.g., secondary APs, slave APs, anchors or the like). The network device may be configured to manage the network cluster. In many embodiments, the process 700 may assign a priority order to the plurality of peer devices (block 710). The plurality of peer devices may be devices or anchors with known locations in a given area. For example, the peer devices may be fixed reference points placed strategically within the given area for device localization. Each peer device may belong to one or more network clusters, each managed by one network device, for example, a designated reference AP. When the peer devices transmit messages (e.g., notifications) to the network device without any coordinated timing, the likelihood of message collisions increases because the time difference between when the messages are sent is often shorter than the travel time duration of each message. This lack of coordination can lead to overlapping transmissions, or collisions, at the network device, which can cause data loss or require retransmissions. In other words, this lack of coordination means that multiple peer devices might send their messages almost simultaneously, without considering when others are sending theirs. If the duration of transmission of the messages is longer than the time difference between when the messages are sent, there's a high chance that the messages may overlap. Therefore, in still further embodiments, the process 700 may assign the priority order to the plurality of peer devices based on a distance of each peer device from the network device. The peer device nearest to the network device may be assigned the highest priority in the priority order and the peer device farthest from the network device may be assigned the lowest priority in the priority order.

In a variety of embodiments, the process 700 may receive a blink signal from a wireless transceiver (block 720). The wireless transceiver may be associated with a mobile asset that requires tracking or location detection. The wireless transceiver may be configured to emit the blink signal periodically, randomly, or upon triggering in order to provide information about its location in a given area. The blink signal may be received by the network device and the plurality of peer devices in the vicinity of the wireless transceiver. The blink signal may be a single, brief transmission intended to be received by the plurality of peer devices and the network device.

In a number of embodiments, the process 700 may record a local arrival timestamp of the blink signal (block 730). The local arrival timestamp may be recorded with reference to a clock of the network device. The clock may be equipped in the network device or may be externally coupled to the network device. The clock may be configured to measure the exact time (e.g., the local arrival timestamp) at which the blink signal from the wireless transceiver may be received at the network device.

In a variety of embodiments, the process 700 may receive a set of notifications (block 740). The set of notifications may be received from the plurality of peer devices sequentially in the assigned priority order. The set of notifications may indicate an arrival of the blink signal at the peer devices and a processing time duration of the blink signal taken by respective peer devices. That is to say, the peer devices may be configured to record the processing time duration required to process the blink signal and include the recorded processing time duration in the notification to the network device. The process 700 may then receive the set of notifications that can be utilized for TDoA estimation of the blink signal.

In numerous embodiments, the process 700 may assess a latency value associated with each notification (block 750). The network device may experience some delay or latency when receiving notifications from the peer devices. This latency could result from factors that may include, for example, communication delays, processing time, or network transmission time. For example, the process 700 may determine a travel time duration associated with each notification to reach the network device from the corresponding peer device. The travel time duration may be determined based on the known location of the peer device and the distance between the peer device and the network device. In numerous additional embodiments, the process 700 may extract the processing time duration from each notification. Consequently, the process 700 may assess the latency value for each notification by considering both the processing time and the travel time duration associated with that notification.

In further embodiments, the process 700 may determine a time of arrival of the blink signal at each peer device (block 760). For example, in order to determine an accurate ToA of the blink signal at a first peer device with reference to the clock of the network device, the process 700 may first record, with reference to the clock, a first arrival timestamp of a notification received at the network device from the first peer device. Likewise, the process 700 may record, with reference to the clock, a second arrival timestamp of a notification received at the network device from the second peer device. That is to say, the process 700 may keep recording an arrival timestamp for every notification that the process 700 may receive from the peer devices. In other words, the process 700 may log the time indicated by the clock when each notification is received at the network device. Once the arrival timestamps and the latency values associated with each received notification are available, the process 700 may determine the ToA of the blink signal at each peer device with reference to the clock of the network device. For example, for the notification from the first peer device, the process 700 may subtract the corresponding latency value from the first arrival timestamp and determine a resultant third arrival timestamp as the ToA of the blink signal at the first peer device with reference to the clock of the network device. That is to say, the third arrival timestamp is determined based on the first arrival timestamp and the assessed latency value associated with the notification from the first peer device. Likewise, for the notification from the second peer device, the process 700 may subtract the corresponding latency value from the second arrival timestamp and determine a resultant fourth arrival timestamp as the ToA of the blink signal at the second peer device. That is to say, the fourth arrival timestamp is determined based on the second arrival timestamp and the assessed latency value associated with the notification from the second peer device. In other words, the process 700 may determine the ToA of the blink signal at each peer device by subtracting corresponding latency value from the recorded arrival timestamp of the corresponding notification at the network device. Therefore, the process 700 may determine the ToA of the blink signal at multiple peer devices even without clock synchronization.

In still additional embodiments, the process 700 may estimate, for each device pair of a plurality of device pairs, a TDoA for the blink signal (block 770). A “device pair” of the plurality of device pairs may include one of a combination of the network device and a peer device of the plurality of peer devices or a combination of two peer devices of the plurality of peer devices. In an example embodiment, the TDoA of the blink signal for the device pair that may be a combination of the network device and a peer device may be estimated as a function of the local arrival timestamp and the determined ToA of the blink signal for the peer device. Further, the process 700 can estimate the TDoA for a device pair, consisting of two peer devices, as a function of the determined ToAs of the blink signal for both peer devices. Continuing the above example, the TDoA for a device pair including the first peer device and the second peer device may be estimated as a function of the third arrival timestamp and the fourth arrival timestamp. Therefore, the TDoA for each device pair can be determined independently of whether the peer devices are synchronized with the clock of the network device or not.

In still further embodiments, the process 700 may determine if notifications are received from a required number of peer devices (block 775). It is important to receive the required number of notifications to estimate sufficient TDoA data to form a required set of non-linear equations that may enable accurate location detection of the wireless transceiver. Solving the required set of non-linear equations (e.g., hyperbolic equations) may lead to the generation of intersecting hyperbolas. If the intersecting hyperbolas are less than the required number, the wireless transceiver may not be accurately located. Thus, if the notifications are not received from the required number of peer devices, the process 700 may keep on checking for notifications received at the network device (block 775).

However, if the process 700 may determine that the notifications are received from the required number of peer devices, in yet more embodiments, the process 700 may determine a location of the wireless transceiver (block 780). The location of the wireless transceiver (e.g., the tag) may be determined based on the estimated TDoAs of the required number of device pairs. In other words, the process 700 may aggregate all TDoAs from all device pairs to form the set of hyperbolic equations. By solving the set of hyperbolic equations, the process 700 may generate a set of intersecting hyperbolas That may represents all possible points where the wireless transceiver could be located. With device pairs spread across the network cluster, a greater number of hyperbolas may be generated. The point or an area where the hyperbolas intersect indicate the location of the wireless transceiver.

Although a specific embodiment for estimation of time difference of arrival (TDoA) based on a priority order suitable for carrying out the various steps, processes, methods, and operations described herein is discussed with respect to FIG. 7, any of a variety of systems and/or processes may be utilized in accordance with embodiments of the disclosure. For example, the process 700 may still be able to locate the wireless transceiver even if the network device does not receive the blink signal, provided the network device receives a required number of notifications indicating arrival and processing time duration of the blink signal at the peer devices. The elements depicted in FIG. 7 may also be interchangeable with other elements of FIGS. 1-6 and FIGS. 8-10 as required to realize a particularly desired embodiment.

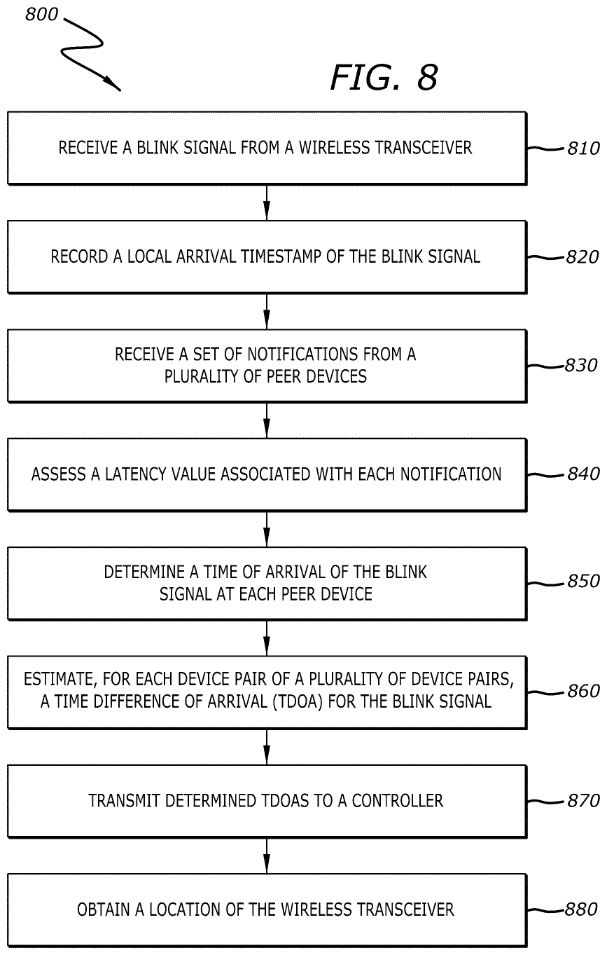

Referring to FIG. 8, a flowchart showing a process 800 for estimation of TDoA in a multi-cluster scenario in accordance with various embodiments of the disclosure is shown. The process 800 may be performed at one or more network devices that may be configured to manage one or more network clusters. A “network cluster” may refer to a group of peer devices (e.g., secondary APs, anchors, or the like) that are managed by a designated network device (e.g., a reference AP). Thus, each network cluster may be managed by the designated reference AP responsible for localizing a wireless transceiver (e.g., a mobile device, a tag) within a given area. In many embodiments, the process 800 may receive a blink signal from the wireless transceiver (block 810). When the wireless transceiver emits the blink signal, the blink signal may also be received by the peer devices associated with the one or more network clusters and a network device.

In a variety of embodiments, the process 800 may record a local arrival timestamp of the blink signal (block 820). The local arrival timestamp of the blink signal may be recorded by the process 800 with reference to a clock of the network device. The clock may be utilized by the process 800 to record the exact time (e.g., the local arrival timestamp) at which the blink signal from the wireless transceiver is received by the process 800. In various embodiments, the process 800 may be executed by the network device.

In additional embodiments, the process 800 may receive a set of notifications (block 830). The set of notifications may be received from the plurality of peer devices sequentially in an assigned priority order. The priority order may be assigned in a number of stages of transmission depending on the number of network clusters a peer device is associated with. In numerous embodiments, the peer devices belonging to a single cluster may be assigned the first stage of transmission. Accordingly, the peer devices associated with the least count of network clusters may be sorted in the first stage of transmission. The peer devices within a particular stage may be further assigned a priority order based on a distance between respective peer devices and the network device associated with the particular network cluster. Thus, the peer device closest to the network device may be assigned the highest priority order and the peer device farthest from the network device may be assigned the least priority order, within any stage of transmission. The peer devices of that particular cluster may transmit the set of notifications sequentially as per their stage of transmission and the priority order within the stage of transmission. Thus, in a first stage of transmission, the process 800 may sequentially receive notifications from peer devices exclusively belonging to the network cluster of the network device. Further, in a second stage of transmission, the process 800 may sequentially receive notifications from peer devices belonging to two network clusters. Likewise, in an N^{th} stage of transmission, the process 800 may sequentially receive notifications from peer devices belonging to N network clusters. As previously shown in FIG. 3, AP 8 belongs to three network clusters and is the last in the priority order. Each of set of notifications may indicate an arrival of the blink signal and a processing time duration of the blink signal at respective peer devices.

In more embodiments, the process 800 may assess a latency value associated with each notification (block 840). For example, the process 800 may determine a travel time duration associated with each notification to reach the network device from the corresponding peer device. The travel time duration may be determined based on the known location of the peer device and the distance between the peer device and the network device. In numerous additional embodiments, the process 800 may extract the processing time duration from each notification. Consequently, the process 800 may assess the latency value for each notification by considering both the processing time and the travel time duration associated with that notification.

In further embodiments, the process 800 may determine a time of arrival of the blink signal at each peer device (block 850). In order to determine the ToA of the blink signal at a corresponding peer device with reference to the clock of the network device, the process 800 may first record, with reference to the clock, a first arrival timestamp of each notification received at the network device. Once the first arrival timestamp and the latency values associated with each received notification are available, the process 800 may determine the ToA of the blink signal at each peer device with reference to the clock of the network device. For example, for each notification, the process 800 may subtract the corresponding latency value from the respective first arrival timestamp and determine the resultant as the ToA of the blink signal at the corresponding peer device.

In still additional embodiments, the process 800 may estimate, for each device pair of a plurality of device pairs, a TDoA for the blink signal (block 860). A “device pair” of the plurality of device pairs may include one of a combination of the network device and any of the managed peer devices or a combination of any two peer devices managed by the network device. In an example embodiment, the TDoA of the blink signal for the device pair that may be a combination of the network device and a peer device may be estimated as a function of the local arrival timestamp and the determined ToA of the blink signal for the peer device. The process 800 can estimate the TDoA for a device pair, consisting of two peer devices, as a function of the determined ToAs of the blink signal for both peer devices.

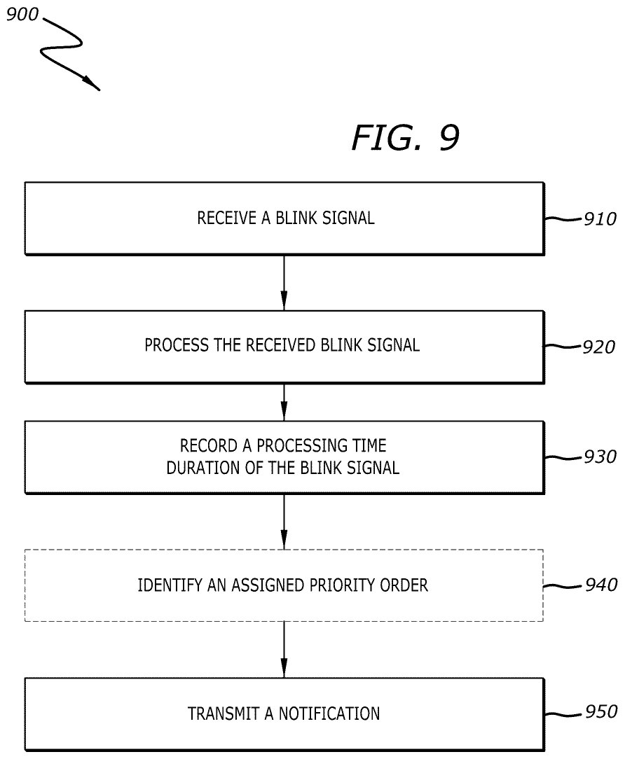

In still further embodiments, the process 800 may transmit the determined TDoAs to a controller (block 870). The controller may be communicatively coupled various network devices in the multi-cluster network, and thus may receive determined TDoAs from various network devices for the same blink signal. All received TDoAs may be aggregated by the controller for localization of the wireless transceiver. Embodiments for localization of the wireless transceiver by the controller are described in detail in conjunction with FIG. 9.

In some more embodiments, the process 800 may obtain a location of the wireless transceiver (block 880). The process 800 may obtain the location of the wireless transceiver from the controller in response to transmitting the estimated TDoAs. The process 800 may keep tracking the movement of the wireless transceiver and can display the determined locations on a map or transmit location data to other systems or applications.

Although a specific embodiment for estimation of TDoA in multi-cluster scenario suitable for carrying out the various steps, processes, methods, and operations described herein is discussed with respect to FIG. 8, any of a variety of systems and/or processes may be utilized in accordance with embodiments of the disclosure. For example, a device pair for estimating TDoA may include a combination of a network device and a peer device belonging to a different network cluster or a combination of two peer devices of different network clusters. The elements depicted in FIG. 8 may also be interchangeable with other elements of FIGS. 1-7, 9, and 10 as required to realize a particularly desired embodiment.

Referring to FIG. 9, a flowchart showing a process 900 for transmission of a notification by a peer device for device localization in accordance with various embodiments of the disclosure is shown. The network may include a network device designated as a reference AP and various peer devices (e.g., anchors, secondary APs, or the like) that form a cluster for device localization. A wireless transceiver may emit a blink signal that is detectable by the surrounding peer devices, including the network device. In many embodiments, the process 900 may receive the blink signal (block 910). To track the location of the wireless transceiver, the peer devices may keep their receiver on and listen for “blinks” from the wireless transceiver. Each peer device and the network device may record respective timestamps of receiving the blink signal.

In a variety of embodiments, the process 900 may process the received blink signal (block 920). Processing the received blink signal can be a complex, multi-step procedure that involves conversion of raw signal data into accurate and actionable location information. After receiving the blink signal, the process 900 may extract essential information, such as a wireless transceiver identity associated with the blink signal. The processing might involve signal validation, amplification, noise filtering, and time-stamping to subsequently include information into a notification. The process 900 may validate the blink signal and confirm whether the blink signal is from a registered wireless transceiver.

In a variety of embodiments, the process 900 may record a processing time duration of the blink signal (block 930). In other words, the process 900 may record the time taken to process the blink signal, from when it was first detected until the processing is complete. The processing time duration may be then included in a notification to be transmitted to the network device for accurate estimation of TDoA. For example, if the process 900 took 5 ms to process the blink signal, this processing time duration is recorded and inserted in the notification.

In still additional embodiments, the process 900 may identify an assigned priority order (block 940). If there are multiple peer devices in a network cluster (e.g., AP1, AP2, AP3) that receive the same blink signal, the peer devices may be assigned a priority order (AP1>AP2>AP3) to send respective notifications to the network device. The priority order may be assigned based on a distance of the peer device from the network device. A peer device nearest to the network device may be assigned the highest priority in the priority order and a peer device farthest from the network device may be assigned the lowest priority in the priority order.

In further embodiments, the process 900 may transmit the notification (block 950). In various embodiments, the process 900 may transmit the notification as per the assigned priority order. For example, the process 900 may wait for its turn as per the assigned priority order for transmitting the notification. Such wait time may also be included as a part of the processing time duration. In one or more embodiments, the wait time may be proportional to a frame duration of the notification. The notification may be configured to indicate an arrival of the blink signal at the peer device and the recorded processing time duration. In several embodiments, the process 900 may include a ToA of the blink signal recorded based on a local clock of the peer device in the transmitted notification. The notification may be finally transmitted to the network device for TDoA estimation for the blink signal and in turn for localization of the wireless transceiver.

Although a specific embodiment for transmission of a notification by a peer device for device localization suitable for carrying out the various steps, processes, methods, and operations described herein is discussed with respect to FIG. 9, any of a variety of systems and/or processes may be utilized in accordance with embodiments of the disclosure. For example, in a multi cluster network scenario, where a peer device belongs to more than one network cluster, the process 900 may assign a priority order based on a count of network clusters the peer device is associated with. The elements depicted in FIG. 9 may also be interchangeable with other elements of FIGS. 1-8 and 10 as required to realize a particularly desired embodiment.

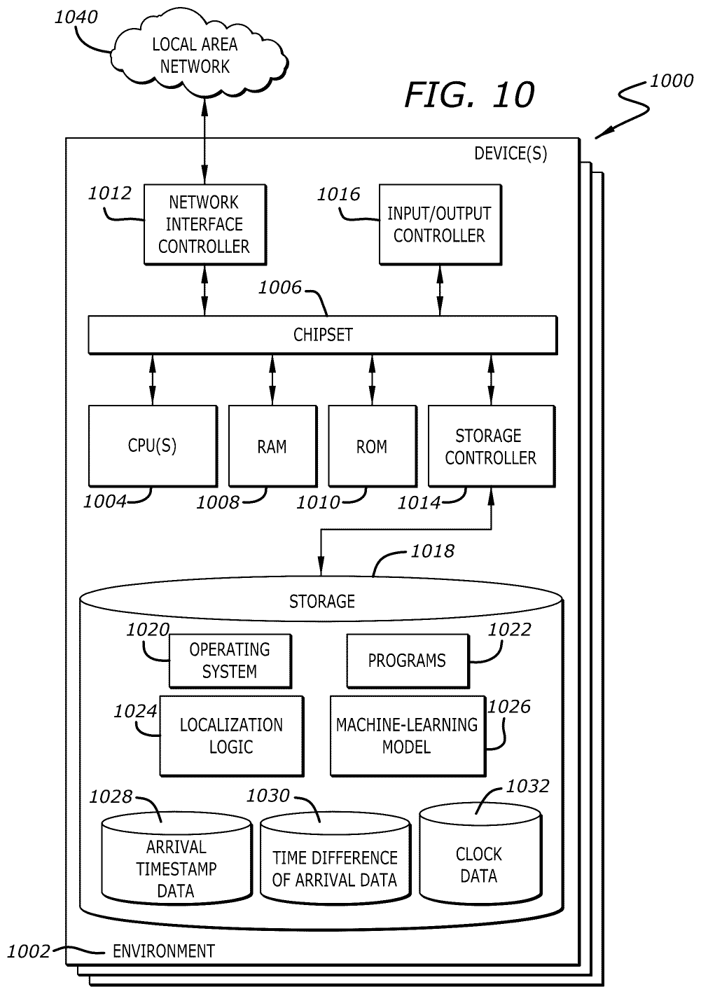

Referring to FIG. 10, a conceptual block diagram of a device 1000 suitable for configuration with a localization logic in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many nonlimiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022 (shown as “programs” in FIG. 1000), device arrival timestamp data 1028, time difference of arrival (TDoA) data 1030, and clock data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer executable instructions may be stored as application 1022 and transform the device 1000 by specifying how the processor(s) 1004 can transition between states, as described above. In some embodiments, the device 1000 has access to computer-readable storage media storing computer executable instructions which, when executed by the device 1000, perform the various processes described above with regard to FIGS. 1-10. In certain embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many further embodiments, the device 1000 may include a localization logic 1024. The localization logic 1024 can be configured to perform one or more of the various steps, processes, operations, and/or other methods that are described above. Often, the localization logic 1024 can be a set of instructions stored within a non-volatile memory that, when executed by the processor(s) 1004 can carry out these steps, etc. In numerous embodiments, the localization logic 1024 may perform various operations related to device localization that is independent of clock synchronization. In some embodiments, the device 1000 can be an AP. In such embodiments, the localization logic 1024 may be configured to receive a blink signal and a set of notifications from a plurality of peer devices. Each notification of the set of notifications may be configured to indicate an arrival and a processing time duration of the blink signal at a corresponding peer device of the plurality of peer devices. The localization logic 1024 may further be configured to assess a latency value associated with each of the set of notifications and estimate, for each device pair of a plurality of device pairs, a TDoA for the blink signal based on a clock associated with the device 1000 and the assessed latency value. Based on the estimated TDoA, the localization logic 1024 may be configured to determine a location of a wireless transceiver that had transmitted the blink signal.

In further embodiments where the device 1000 corresponds to a peer device managed by a reference AP in a network cluster, the localization logic 1024 may be configured to receive a blink signal from the wireless transceiver, process the blink signal, record a processing time duration of the blink signal, and transmit a notification, indicating an arrival and the processing time duration of the blink signal, to the reference AP. The notification can be utilized for TDoA estimation of the blink signal at the reference AP.

In various embodiments, the storage 1018 can include the arrival timestamp data 1028. The arrival timestamp data 1028 may refer to the precise timestamp recorded when a signal, such as a blink from a wireless transceiver, a notification from a peer device, etc. is received by the localization logic 1024. In other words, the arrival timestamp data 1028 may include a list of ToAs of various signals received by the device 1000. Further, the arrival timestamp data 1028 may include ToAs (e.g., second arrival timestamps referred to in the foregoing description of FIGS. 2 and 3) of the blink signal at various peer devices determined by the localization logic 1024 with reference to the clock of the device 1000. The arrival timestamp data 1028 may be utilized by the localization logic 1024 for techniques such as TDoA estimation and in turn device localization.

In still more embodiments, the storage 1018 can include the TDoA data 1030. The TDoA data 1030 may store TDoA of the blink signal for a plurality of device pairs. A device pair of the plurality of device pairs may include one of a combination of a reference AP and a peer device managed by the reference AP or a combination of two peer devices managed by the reference AP. The TDoA data 1030 may be utilized by the localization logic 1024 for device localization independent of clock synchronization.

In a number of embodiments, the storage 1018 can include clock data 1032. The clock data 1032 may refer to a logic, an algorithm, an application, one or more instructions, etc. utilized by the device 1000 to maintain time. For example, a software clock can run by periodically updating time based on system ticks or an internal reference points. The clock data 1032 may provide the rules and intervals to simulate real-time progression, enabling the device 1000 to generate timestamps and manage time-dependent processes. However, the device 1000 can further include a hardware logic to implement the clock for time-keeping.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the arrival timestamp data 1028, the TDoA data 1030, and the clock data 1032, and utilize the learning to predict future outcomes. For example, the ML model(s) 1026 can be trained to predict a movement of a wireless transceiver based on device localization performed by the localization logic 1024. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a localization logic for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although a specific embodiment for a conceptual block diagram of the device 1000 suitable for configuration with the localization logic suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor, wherein the device is associated with a clock; and
a memory communicatively coupled to the processor, wherein the memory comprises a localization logic that is configured to:
receive a blink signal and a set of notifications, wherein each notification of the set of notifications is configured to indicate an arrival and a processing time duration of the blink signal at a corresponding peer device of a plurality of peer devices;
assess a latency value associated with each of the set of notifications; and
estimate, for each device pair of a plurality of device pairs, a time difference of arrival (TDoA) for the blink signal based on the clock and the assessed latency value.

2. The device of claim 1, wherein a device pair of the plurality of device pairs comprises one of a combination of the device and a peer device of the plurality of peer devices or a combination of two peer devices of the plurality of peer devices.

3. The device of claim 2, wherein to estimate the TDoA for the device pair comprising the combination of the device and the peer device, the localization logic is further configured to:
record, with reference to the clock, a local arrival timestamp of the blink signal at the device and a first arrival timestamp of a notification of the set of notifications at the device, wherein the notification is received from the peer device; and
determine a second arrival timestamp of the blink signal at the peer device based on the first arrival timestamp and the assessed latency value associated with the notification, wherein the TDoA of the blink signal for the device pair is estimated as a function of the local arrival timestamp and the second arrival timestamp.

4. The device of claim 2, wherein to estimate the TDoA for the device pair comprising the combination of the two peer devices, the localization logic is further configured to:
record, with reference to the clock, a first arrival timestamp of a first notification and a second arrival timestamp of a second notification, of the set of notifications at the device, wherein the first notification is received from a first peer device of the two peer devices and the second notification is received from a second peer device of the two peer devices; and
determine a third arrival timestamp of the blink signal at the first peer device and a fourth arrival timestamp of the blink signal at the second peer device, wherein the third arrival timestamp is determined based on the first arrival timestamp and the assessed latency value associated with the first notification, and the fourth arrival timestamp is determined based on the second arrival timestamp and the assessed latency value associated with the second notification, and wherein the TDoA of the blink signal for the device pair is estimated as a function of the third arrival timestamp and the fourth arrival timestamp.

5. The device of claim 1, wherein in response to receiving the set of notifications, the localization logic is further configured to determine a travel time duration associated with each notification of the set of notifications.

6. The device of claim 5, wherein a location of each of the plurality of peer devices is known to the localization logic, and wherein the travel time duration associated with each notification of the set of notifications is determined based on the known location of the corresponding peer device.

7. The device of claim 5, wherein the latency value for each notification of the set of notifications is assessed based on the processing time duration and the travel time duration associated with a corresponding notification of the set of notifications.

8. The device of claim 1, wherein the localization logic is further configured to assign a priority order to the plurality of peer devices.

9. The device of claim 8, wherein one or more notifications in the set of notifications are received sequentially based on the priority order.

10. The device of claim 8, wherein the priority order is assigned based on a distance of each peer device of the plurality of peer devices from the device.

11. The device of claim 10, wherein a peer device, of the plurality of peer devices, nearest to the device is assigned a highest priority in the priority order.

12. The device of claim 8, wherein the priority order is assigned based on a count of network clusters each peer device of the plurality of peer devices is associated with.

13. The device of claim 12, wherein a peer device, of the plurality of peer devices, associated with a least count of network clusters is assigned a highest priority in the priority order.

14. The device of claim 1, wherein the blink signal is received from a wireless transceiver.

15. The device of claim 14, wherein the localization logic is further configured to determine a location of the wireless transceiver based on the estimated TDoA associated with each device pair of the plurality of device pairs.

16. The device of claim 1, wherein the device corresponds to a reference access point (AP) and the plurality of peer devices correspond to secondary APs.

17. The device of claim 1, wherein the TDoA for each device pair of the plurality of device pairs is estimated independently of whether the plurality of peer devices are clock synchronized with the clock of the device.

18. A peer device, comprising:
a processor; and
a memory communicatively coupled to the processor, wherein the memory comprises a localization logic that is configured to:
receive a blink signal;
record a processing time duration of the blink signal; and
transmit a notification, indicating an arrival and the processing time duration of the blink signal, to a reference device, wherein the notification is utilized for time difference of arrival (TDoA) estimation of the blink signal at the reference device.

19. The peer device of claim 18, wherein the peer device is associated with one or more network clusters.

20. A method, comprising:
receiving a blink signal and a set of notifications, wherein each notification of the set of notifications is configured to indicate an arrival and a processing time duration of the blink signal at a corresponding peer device of a plurality of peer devices;
assessing a latency value associated with each of the set of notifications; and
estimating, for each device pair of a plurality of device pairs, a time difference of arrival (TDoA) for the blink signal based on a reference clock and the assessed latency value.
